(19) United States
(12) Patent Application Publication
(10) Pub. No.: US 2024/0411989 A1
(43) Pub. Date: Dec. 12, 2024

(54) METHODS AND SYSTEMS FOR ENHANCING USER INTERACTION WITH ASSISTIVE TECHNOLOGY

(71) Applicant: United States Government as Represented by the Department of Veterans Affairs, Washington, DC (US)

(72) Inventor: Nicholas Jeremy Hill, Albany, NY (US)

(21) Appl. No.: 18/735,896

(22) Filed: Jun. 6, 2024

Related U.S. Application Data
(60) Provisional application No. 63/471,391, filed on Jun. 6, 2023.

(51) Int. Cl. G06F 40/274; G06F 40/166

(52) U.S. Cl. CPC G06F 40/274; G06F 40/166

(57) ABSTRACT

Methods and systems are described for enhancing user interaction with assistive technology. An input associated with a message may be received from an assistive communication device. A next likely input associated with the message may be determined. The input associated with the message and the next likely input associated with the message may be sent to a user device via a secure communication session. Output of the input associated with the message and output of a prompt to query a user of the assistive communication device of the accuracy of the next likely input associated with the message may be caused via an interface of the user device. An indication that the next likely input associated with the message is accurate may be received via the secure communication session. The message may be updated based on the next likely input associated with the message and caused to be output.

### CROSS-REFERENCE TO RELATED APPLICATIONS

This application claims priority to and the benefit of U.S. Provisional Patent Application No. 63/471,391, filed Jun. 6, 2023, the entire contents of which are hereby incorporated herein by reference in its entirety.

### BACKGROUND

Individuals with disabilities often face substantial challenges in communicating effectively, particularly when it comes to using technology to aid in their interactions. Traditional assistive technologies have provided various input methods, such as specialized keyboards, voice recognition software, and eye-tracking systems, to facilitate communication for users with disabilities. However, these methods have inherent limitations that can hinder the speed and case of communication.

One of the primary issues with prior art in assistive technology is the prolonged duration it takes for users to spell out words and construct messages. This is especially true for individuals who rely on methods that translate subtle physical movements or neural signals into digital text. The process of selecting each letter and forming words can be painstakingly slow and laborious, often leading to frustration and fatigue for the user. This slow pace of text entry no longer just affects the ability of the user to communicate in a timely manner, but also impacts their ability to engage in dynamic conversations, which can be particularly disadvantageous in both personal and professional settings.

Moreover, existing systems may not offer sufficient predictive capabilities to anticipate the intended message of the user, which could otherwise accelerate the communication process. The lack of advanced predictive text features that adapt to the personal communication style of the user further exacerbates the problem, as generic predictions do not account for individual vocabulary preferences and patterns.

In addition, the prior art often does not provide an efficient means for a third party to assist the user with a disability in the communication process. This lack of support can leave users feeling isolated and dependent on their limited ability to interact with the assistive technology.

The present disclosure seeks to address these and other deficiencies in the prior art by providing methods and systems that enhance user interaction with assistive technology, thereby enabling users with disabilities to communicate more efficiently and effectively.

### SUMMARY

The disclosed methods and systems aim to improve communication for users with disabilities by integrating assistive input methods with software on computing devices to facilitate message composition and interaction. Features include the ability for software to receive inputs from various assistive devices and display composed text, generate machine-readable symbols for secure mobile device communication, and present predictive questions to expedite message completion. Additionally, the software can adapt to user preferences and physical conditions, provide feedback mechanisms, and support third-party assistance through a mobile interface. This enhances the efficiency and effectiveness of communication for users with disabilities, addressing limitations of prior assistive technologies.

For example, a computing device may receive, from an assistive communication device, an input associated with a message. The message may comprise one or more of a word, a partial word, a letter, or a sentence. The computing device may determine a next likely input associated with the message. The next likely input may comprise one or more of a letter, a word, punctuation, or a phrase. The computing device may send, via a secure communication session, to a user device, the input associated with the message and the next likely input associated with the message. The next likely input may be determined based on one or more of an alphabetical grid, a Bayesian mode, or a large language model. The next likely input may be determined based on a machine-learning model. The computing device may cause, via the secure communication session, via an interface of the user device, output of the input associated with the message and output of a prompt to query a user of the assistive communication device of the accuracy of the next likely input associated with the message. The prompt may comprise one or more of a “yes” indicator or a “no” indicator. The computing device may receive, via the secure communication session, an indication that the next likely input associated with the message is accurate. The computing device may update, based on the next likely input associated with the message, the message and cause the message to be output.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example communication system;

FIG. 2 shows an example user interface;

FIG. 3 shows an example system;

FIG. 4 shows an example diagram;

FIG. 5 shows an example system;

FIG. 6A shows an example method;

FIG. 6B shows an example method;

FIG. 7 shows an example diagram;

FIG. 8A shows an example method;

FIG. 8B shows an example method;

FIG. 9A shows an example graph;

FIG. 9B shows an example graph;

FIG. 10A shows an example graph;

FIG. 10B shows an example graph;

FIG. 11 shows an example system;

FIG. 12 shows an example method;

FIG. 13 shows an example method;

FIG. 14 shows an example method;

FIG. 15 shows an example method; and

FIG. 16 shows an example system.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The technical problem addressed by the present disclosure arises from the limitations inherent in existing assistive technologies used by individuals with disabilities for communication. Traditional systems often rely on input methods that are not optimized for speed or case of use, particularly for those who utilize subtle physical movements or neural signals to interact with technology. The slow and cumbersome process of constructing messages letter by letter can lead to user fatigue and hinder the ability to participate in dynamic conversations. Furthermore, the lack of personalized predictive text capabilities in current technologies fails to adequately anticipate the intended message of the user, thereby prolonging the communication process. Additionally, the absence of an effective mechanism for third-party assistance exacerbates the communication challenges faced by users with disabilities, often resulting in a sense of isolation and dependence.

The present disclosure provides a technical solution to these problems by introducing methods and systems that enhance user interaction with assistive technology. The disclosed methods and systems integrate advanced assistive input methods with sophisticated software on computing devices, enabling users with disabilities to compose messages more efficiently. The software is designed to receive inputs from a variety of assistive devices and display the composed text on a screen, while also generating machine-readable symbols to establish secure communication with a mobile device. This allows a third party to assist in message composition through a mobile interface, which includes features for displaying text, presenting predictive questions, and facilitating third-party interaction to support efficient communication. The adaptability of software to user preferences and physical conditions, coupled with its ability to provide feedback mechanisms, represents a substantial improvement over prior art, offering users with disabilities a more effective means of communication.

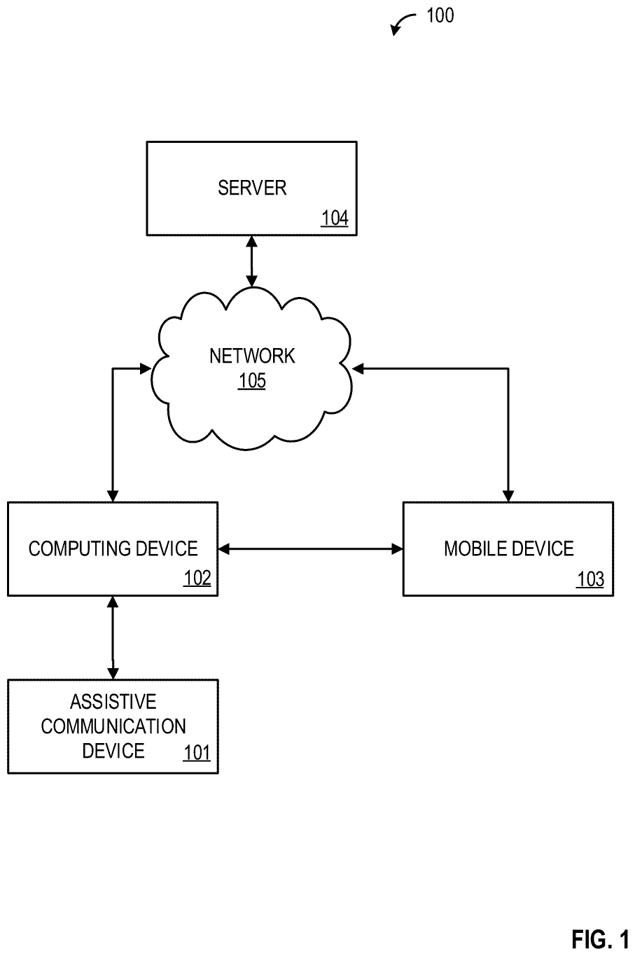

FIG. 1 is a block diagram of an example communication system 100 showing the interaction between various components designed to enhance the communication abilities of users with disabilities. The system 100 may include an assistive communication device 101. The assistive communication device 101 may be an input mechanism for the user. The assistive communication device 101 may operate in several modes to accommodate different types of disabilities and user preferences.

Examples of the assistive communication device 101 may include, but are not limited to, a brain-computer interface, a muscle movement sensor, an eye-direction detector, a sip-and-puff system, which allow a user with a disability to issue commands through inhaling or exhaling; a switch-based device that may be activated by various body parts of the user with a disability; a voice-activated system that convert spoken words into text; and a specialized joystick that may be manipulated by a user with limited motor control. Additionally, the assistive communication device 101 may include an adaptive keyboard with customizable layouts and keys and/or one or more foot pedals that can be used to select letters or activate functions within the communication software. The assistive communication device 101 may be designed to ensure that the selections of a user with a disability are accurately captured and reflected in the text displayed on the screen. For example, the assistive communication device 101 may also include environmental control units that may enable users to interact with their surroundings, such as adjusting room temperature or controlling lights, as part of their communication setup. Each of these assistive communication devices 101 may be configured to work in conjunction with the predictive and adaptive features of the software to enhance the overall communication experience for the user with a disability.

The assistive communication device 101 may be in communication with a computing device 102 through various means, either wired or wireless. In some aspects, the assistive communication device 101 may connect to the computing device 102 via a wired connection, such as USB, HDMI, or other suitable interfaces that provide a reliable and secure transmission of signals. In other examples, the assistive communication device 101 may communicate wirelessly with the computing device 102 using technologies such as Bluetooth, Wi-Fi, infrared, or radio frequency.

The computing device 102 may be equipped with software specifically configured to interpret the signals received from the assistive communication device 101. This software may translate the inputs into letters and words that are then displayed on a display screen of the computing device 102 and/or a display screen of a mobile device 103. For example, the input may include one or more of binary selections, muscle twitches, eye movements, or neural signals, The software is designed to be responsive and adaptive, providing real-time or near-real-time text display that corresponds to the inputs of a user with a disability. This visual feedback helps users with disabilities to effectively communicate and compose messages using the assistive communication device 101.

The software may comprise a kernel (not shown), which is a program that runs on the computing device 102. The kernel may keep a record of all messages that the user types, instantiate the language models for character and word prediction, and decide what question to ask at each step according to multiple sets of rules. Each instance of the kernel may generate a hyperlink, with an associated QR code that can be shown on the screen associated with the computing device 102. Multiple instances of the kernel may run at the same time, intended for access by different users. For example, a first kernel may run for the family of the user, a second kernel may run for the medical team of the user, a third kernel may run for the family lawyer, and a fourth kernel may run for other visitors to the user. Thus, each kernel instance may represent a separate communication channel. Each kernel instance may keep track of an arbitrary number of messages within that channel and allow switching between messages to resume typing any given message or to start a new one.

The assistive communication device 101 and/or the computing device 102 may also be in communication with a network 105. The network 105 may include various interconnected systems and pathways that facilitate data transmission and communication across multiple devices. The network 105 may encompass a wide range of network types, including local area networks (LANs), wide area networks (WANs), and the Internet, which provides a global system of interconnected computer networks. By connecting to the network 105, the computing device 102 may access remote resources, share data, and communicate with other devices and services that are part of the network or within another network.

The Internet, as a component of the network 105, enables the computing device 102 to leverage cloud-based services, access vast databases of information, and interact with online platforms. This connectivity may allow for software updates, synchronization of user data, and providing users with access to a broader range of assistive tools and resources.

Furthermore, the computing device 102 may communicate with a server 104 via the network 105 or another network. The server 104 may be a computer or a plurality of computers that provide various services to other computers or devices on the network 105. The server 104 may host software applications, manage databases, and perform data processing tasks.

In certain examples, some or all of the functionality performed by the computing device 102 may be alternatively performed by the server 104. The functionality may include processing of predictive algorithms, storage of historical input patterns, and management of user profiles. By utilizing the server 104, the system 100 may provide centralized management of the communication services offered to the user with a disability.

The computing device 102 may include a communication interface (not shown) such as a Bluetooth module, a cellular module, a Wi-Fi module, a Zigbee module, an NFC module, or any other short/long range communication module to transmit/receive signals and/or data to/from external devices, such as the assistive communication device 101, the mobile device 103, the server 104, and/or the network 105. For example, the communication interface may establish communication between the computing device 102 and an external device (e.g., the assistive communication device 101, the mobile device 103, the server 104, or the like). For example, the communication interface may communicate with the assistive communication device 101 and/or the mobile device 103 through wireless communication or wired communication. For example, the communication interface may communicate with the server 104 by being connected to the network 105 through wireless communication or wired communication.

In another example, as a cellular communication protocol, wireless communication may be achieved using at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In addition, wireless communication may be achieved using a near-distance communication. The near-distance communications may include, for example, at least one of Bluetooth, Wireless Fidelity (WiFi), Near Field Communication (NFC), Global Navigation Satellite System (GNSS), and the like. The wired communication interface may include, for example, at least one of Universal Serial Bus (USB), High Definition Multimedia Interface (HDMI), Recommended Standard-232 (RS-232), power-line communication, Plain Old Telephone Service (POTS), and the like. The network 105 may include, for example, at least one of a telecommunications network, a computer network (e.g., LAN or WAN), the Internet, or a telephone network.

In addressing the challenge of facilitating third-party assistance in the communication process for users with disabilities, the computing device 102 may be configured to display a machine-readable symbol, such as a QR code, a bar code, another 2-dimensional code, a uniform resource locator (URL), or other type of symbol that can be scanned or accessed by the mobile device 103. This code, symbol, or URL serves as a gateway for the mobile device 103 to establish a connection with the computing device 102 and/or the server 104. For example, the connection between the mobile device 103 and the computing device 102 may be a secure connection. Once the connection is established, the mobile device 103 can render an interface designed to assist in the communication process.

Examples of the mobile device 103 may include smartphones, laptop computers, tablet computers, smartwatches, or other portable electronic devices with scanning capabilities. The mobile device 103 may be equipped with a camera to scan a machine-readable code or symbol. The mobile device 103 may include touchscreens to facilitate interaction with the interface generated by the software on the computing device 102. The mobile device 103 may facilitate the interaction with the interface generated by the software on the computing device 102 without couch screens, for example, using voice command. The mobile device 103 may also include software applications designed to enhance accessibility for users with disabilities, such as screen readers, voice control features, or braille display compatibility. Additionally, wearable devices such as smartwatches or smart glasses may serve as the mobile device 103, providing a hands-free option for the third party to assist the user with a disability. These wearable devices can offer convenience and case of use, especially in situations where the third party requires mobility while assisting the user. Furthermore, the mobile device 103 may be configured to connect to external peripherals, such as keyboards or pointing devices, to offer additional methods for the third party to interact with the interface and assist in the communication process.

The secure connection (or secure messaging) may improve the likelihood that the data exchanged between the computing device 102 and the mobile device 103 is protected from unauthorized access or interception. The security measures implemented to assist with the secure connection may include encryption protocols, authentication procedures, and secure channel establishment techniques for protecting digital communications.

The secure connection (or secure messaging) relay may be configured to run on an internet-connected server (e.g., the server 104). Operating on an internet-connected server allows the client software of the mobile device 103 and the software of the computing device 102 to find each other relatively quickly, without having to put the mobile device 103 onto the same local network or perform any other configuration steps. For example, the separation of the software running on the computing device 103 and the user interface displayed on the mobile device 103 may allow a conversation partner or third-party assistant to act from a remote location, for example in the context of a telehealth video call.

Through this secure connection, the mobile device 103 may be able to present an interface that may include a variety of tools and features to aid the third party in assisting the user with a disability. This interface can display the text being composed by the user, offer predictive questions or suggestions to expedite message completion, and provide options for the third party to input their responses or contributions to the communication. The interface may be customized to the preferences of the third party or adapted to the one or more requirements of the communication scenario.

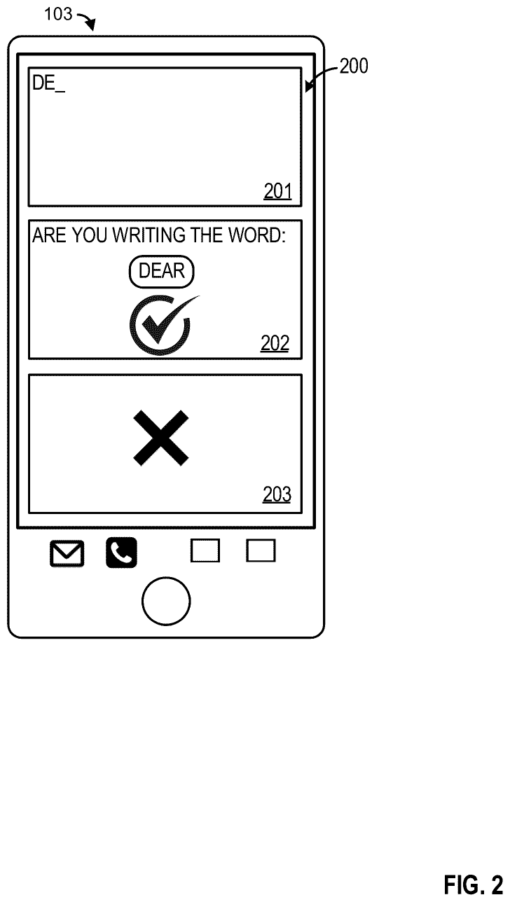

FIG. 2 shows a view of an example user interface 200 on the mobile device 103 to facilitate communication for a user with a disability. Referring to FIG. 2, the user interface 200 may be implemented in HTML5, CSS, JavaScript, or the like. For example, the user interface 200 may be generated and displayed in a web browser, for example, on the mobile device 103. The mobile device 103 may scan a QR code, bar code, another 2-dimensional code, or a hyperlink provided by and/or displayed on a display screen associated with the computing device 102. Based on the mobile device 103 scanning the QR code, bar code, another 2-dimensional code, or the hyperlink, the mobile device 103 may establish a secure connection with the computing device 102 and become a client device. If multiple client devices connect simultaneously via the same QR code or link, the multiple client devices may experience the effect of the actions of the other client devices in real-time or near real-time. In this way, the secure connection may be seamlessly handed over from one third-party assistant as they leave (e.g., taking their smartphone with them) to another who is just arriving (e.g., bringing their smartphone). The seamless handover may enable the computing device 102 to show the message in progress on the screen associated with the computing device 102, effectively mirroring the user interface of the third party assistant, if the user or other visitors would benefit from seeing it.

The user interface 200 may be divided into three portions to streamline the communication process. The first portion 201 of the user interface 200 may display the text that the user with a disability is currently spelling out. For example, as shown in FIG. 2, the first portion 201 includes “DE_”. The first portion 201 may also display the message or portion of the message that the user with a disability has typed or indicated is correct so far. This visual representation may allow the user to see their progress in real-time or near-real-time and provides a reference point for both the user and the assisting third party.

The second portion 202 of the user interface 200 presents a question, such as “ARE YOU WRITING THE WORD: DEAR,” which is generated based on the text input by the user. This predictive feature is intended to assist the user in completing their message more quickly by offering suggestions that are likely to match the intended input of the user. The predictive question serves as a time-saving tool, reducing the number of inputs the user with a disability has to make to complete their message.

The second portion 202 may also show the current question to which the answer “yes” or “no” is required, and display the character, set of characters, or suggested word or word completion, that is being offered. The third-party assistant may ensure that this question is conveyed to the user. The second portion 202 of the user interface 200 may provide interactive elements, such as a checkmark to indicate an affirmative response. For example, the second portion 202 may be tapped or clicked by the third-party assistant to indicate that the user accepted the offer.

The third portion 203 of the user interface 200 may also provide interactive elements, such as a square to indicate a negative response. For example, the third portion 203 may be tapped or clicked to indicate that the user declined the offer. These elements enable the user or the third-party assistant to easily confirm or deny the predictive text suggested by the software in manual mode. The inclusion of these interactive elements in the user interface 200 may allow for a more efficient and user-friendly communication experience, as it simplifies the process of responding to the predictive questions and aids in the rapid composition of messages.

Alternatively, the interactive elements (e.g., clicking/tapping) of the second and third portions 202, 203 may be disabled in favor of a single button (e.g., a “GO” button) superimposed between them in automatic mode. In the automatic mode, the third-party assistant may be still responsible for ensuring that the user knows the current question and is ready to answer. When ready, the third-party assistant may press the button and the user interface then waits for the assistive communication device 101 (e.g., a switch, a brain-computer interface, an automated camera classifier, etc.) to classify the response of the user and send the result to the software via the secured connection (or secured messaging). Although it is not shown in FIG. 2, a menu button may give the third-party assistant access to a menu of ancillary options such as switching to another in-progress message, starting a new message, interjecting a “drop-in” yes/no question that is not intended to affect speller output, and selecting the typed text for copy-pasting to another app.

Overall, the user interface 200 on the mobile device 103 is designed to be intuitive and accessible, ensuring that users with disabilities can communicate effectively with the assistance of the software and, if desired, a third party. The division of the user interface 200 into distinct portions for displaying text, offering predictive suggestions, and providing response options reflects the thoughtful integration of user-centric design principles aimed at enhancing the communication capabilities of users with disabilities.

Returning to FIG. 1, the system 100 is designed to operate in various modes, each with distinct features and advantages tailored to meet the diverse communication requirements and preferences of users with disabilities. These modes of operation not merely offer alternative methods of input but also provide strategic benefits that can enhance the overall communication experience. For instance, some modes may prioritize speed and efficiency, enabling users to convey messages more rapidly, which is particularly advantageous in time-sensitive situations. Other modes may focus on precision and ease of use, which can be beneficial for users with limited motor skills or cognitive abilities. Additionally, there are modes that incorporate advanced predictive algorithms, offering more personalized and context-aware assistance that adapts to the individual communication patterns of the user, thereby reducing the cognitive load and expediting the message composition process. Each mode is designed with specific use cases in mind, ensuring that the system can accommodate a wide range of disabilities and situational requirements, ultimately empowering users to communicate with greater independence and confidence.

In the manual mode, the user may interact with the assistive communication device 101 and/or a third-party assistant using physical inputs such as thumb switches, facial muscle twitches, or blinks, which are then translated into letters and words by the computing device 102. This mode allows for direct control by the user but may require more effort and time to compose messages.

The automatic mode is particularly beneficial for users utilizing a brain-computer interface as part of the assistive communication device 101. In this mode, the system can detect neural signals corresponding to the intent of the user to communicate specific letters or words, thereby reducing the physical effort involved in the communication process.

Grid-scanning mode (or grid mode) offers an innovative approach to selecting letters by dividing the alphabet into a grid of rows. The user can indicate their choice of row and letter within that row through simple inputs, streamlining the selection process and potentially increasing the speed of communication.

Bayesian mode (or Bayesian search mode) employs predictive algorithms to anticipate the next letter or word the user intends to input based on their previous interactions. This mode utilizes a Bayesian predictive model that adapts to the communication patterns of the user, making the prediction of text more accurate and personalized.

The computing device 102 processes the inputs received from the assistive communication device 101 in any of the aforementioned modes and displays the composed text on a screen. It also generates a machine-readable symbol, such as a QR code, bar code, another 2-dimensional code, to facilitate a secure connection with the mobile device 103.

The mobile device 103, upon scanning the machine-readable symbol, establishes a secure communication channel with the computing device 102. It then operates as a secure terminal, allowing a third party to assist the user with a disability in message composition. The interface on the mobile device 103 includes portions for displaying the text being spelled out, presenting predictive questions in the relevant mode of operation, and enabling the third party to provide input, thereby enhancing the communication experience for the user with a disability.

In the Bayesian mode, the predictive model operates by employing Bayesian statistical methods to estimate the probability of a particular letter or word being the intended next input of the user. This estimation is based on the context provided by the letters or words already input by the user. The Bayesian predictive model leverages historical data, which includes the past inputs and selections of the user, to make informed predictions about future inputs. This historical data is continuously updated as the user interacts with the system, allowing the model to become more accurate over time.

The training of the Bayesian predictive model on a way of communicating for a particular individual involves collecting and analyzing the input patterns of the individual over a period of time. As the user spells out words and constructs messages, the system records each selection and the context in which it was made. This data forms a personalized dataset that reflects the communication style of the user, including their vocabulary preferences, common phrases, and syntactic tendencies.

The software on the computing device 102 or the server 104 processes this dataset to identify patterns and relationships between different inputs. For example, if the user frequently follows the word “good” with “morning,” the model will learn to predict “morning” as a likely next word after “good” is input. The Bayesian approach allows the model to assign probabilities to various potential next inputs, ranking them based on how likely they are to be the intended choice of the user.

The predictive model may also be trained to recognize and adapt to the physical response patterns of the user, such as the speed and consistency of their inputs, which can vary due to the nature of their disability. This training can help the model adjust the timing and presentation of predictive questions, ensuring that they are aligned with the ability of the user to respond.

As the user continues to use the system, the Bayesian predictive model is refined through a feedback loop. The confirmations or rejections of the predictive suggestions by the user may serve as valuable feedback that the model uses to adjust its predictions. This self-improving mechanism ensures that the model becomes more tailored to the communication style of the user over time, enhancing the efficiency and effectiveness of the communication process.

The Bayesian mode thus offers a dynamic and personalized communication aid that evolves with the user, providing a customized experience that can greatly reduce the cognitive and physical effort involved in composing messages. This mode is particularly advantageous for users with disabilities who have a consistent communication pattern that can be learned and anticipated by the predictive model.

Through the various modes of operation, the system 100 provides a flexible and adaptive solution to overcome the communication barriers faced by users with disabilities, as depicted in FIG. 1.

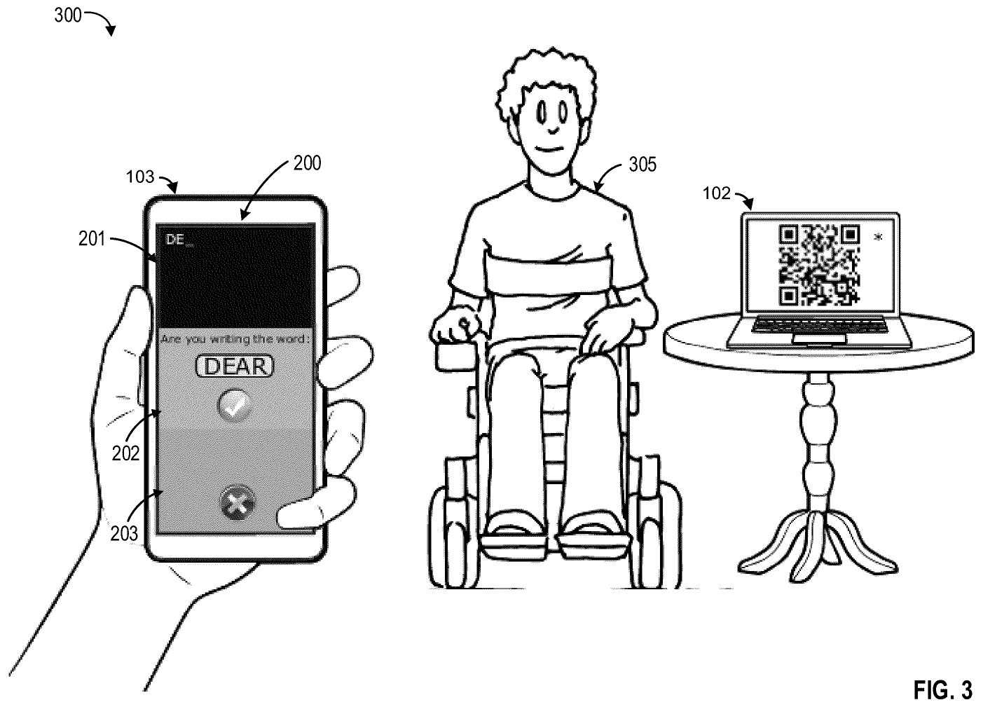

FIG. 3 is an example communication system 300 showing the interaction between various components designed to facilitate communication in manual mode for a user 305 with a disability. The communication system 300 may comprise the assistive communication device 101 (not shown), the computing device 102, and the mobile device 103. In the manual mode, the user 305 may interact with the assistive communication device 101 and/or a third-party assistant, using physical inputs such as thumb switches, facial muscle twitches, or blinks. The assistive communication device 101 may be a switch-based device that can be activated by various body parts, a specialized joystick that can be manipulated by the user 305 with limited motor control, a camera-based system that recognizes the movement of the user 305 of various body parts, and/or foot pedals. The assistive communication device 101 may communicate with the software on the computing device 102, ensuring that the selections of the user 305 with a disability are accurately captured and reflected in the text displayed on the screen. The third-party assistant may be a conversation partner, a human communication partner, a family member, a medical professional, and/or the like. The third-party assistant may observe the body movement of the user 305 (e.g., blink) and enter the selection of the user 305 via the mobile device 103.

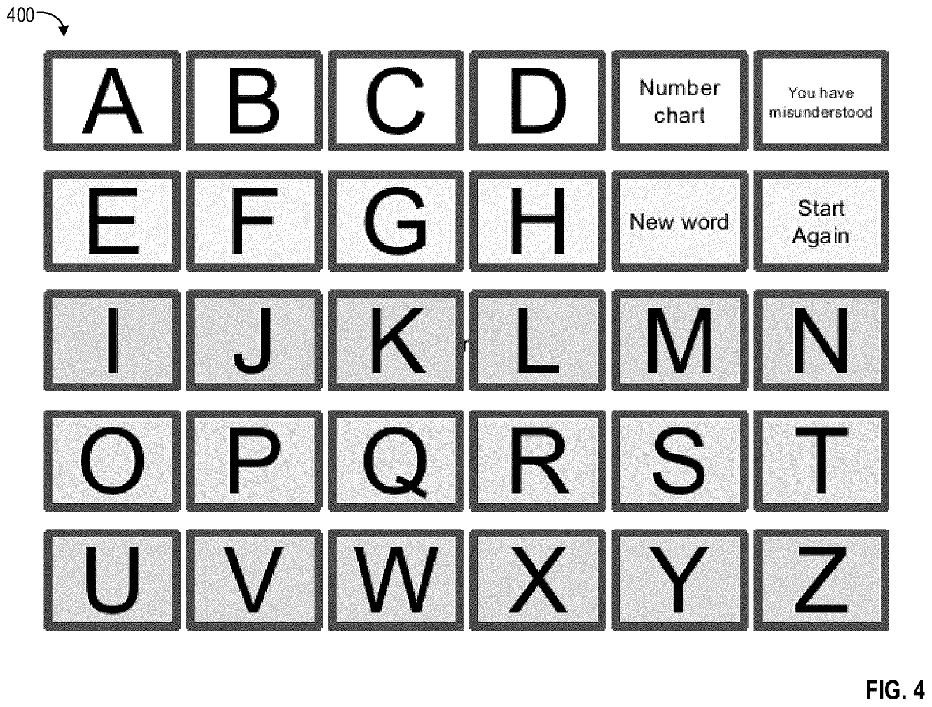

In the manual mode, the computing device 102 or the third-party assistant may ask a systematic series of yes/no questions to determine the communication intent of the user 305. For example, a static grid arrangement of letters 400 as shown in FIG. 4 may be used by the computing device 102 or the third-party assistant to ask yes/no questions to the user 305. Specifically, the computing device 102 may display the yes/no questions to the user 305 with the static arrangement of letters 400 via the screen associated with the computing device 102. The third-party assistant may use a board that displays the static arrangement of letters 400 for the yes/no questions to the user 305. Each question may be one of three types: (1) offering a candidate group of letters (e.g., to be narrowed down by subsequent questions), (2) offering a final choice of letter (e.g., possibly including non-letter options such as “backspace” or “finish”), or (3) offering a possible word completion. Example questions and responses are described in the following interaction, in which the computing device 102 and/or the third-party assistant offers two groups of letters, then two letters, then a word completion: THIRD-PARTY ASSISTANT:

Do you want the first row? USER: No, THIRD-PARTY ASSISTANT: Second? USER: Yes, THIRD-PARTY ASSISTANT: [because the second row contains letters E through H followed by other options] Do you want the letter E? USER: No, THIRD-PARTY ASSISTANT: F? USER: Yes, THIRD-PARTY ASSISTANT: [because the letter F seems likely given previously-written words] Are you writing the word FIRST? USER: Yes.

Once the computing device 102 receives the inputs from the assistive communication device 101, the software on the computing device 102 may translate the inputs, which may include binary selections, muscle twitches, or eye movements, into “yes” or “no” indications. The “yes” or “no” indications may be transmitted to the mobile device 103 with the letter or text questioned to the user 305. The first portion 201 of the user interface 200 may display the letter or text for which the user is asked. The second portion 202 and/or the third portion 203 of the user interface 200 may present the yes/no responses received from the user 305 via the assistive communication device 101. If the user 305 signaled an affirmative response, the second portion 202 of the user interface 200 (e.g., checkmark) may display the “yes” indication of the user 305. If the user 305 signaled a negative response, the third portion 203 of the user interface 200 (e.g., square) may indicate the “no” indication of the user 305. Alternatively or additionally, once the third-party assistant recognizes the yes/no responses of the user, the third-party assistant may tap the screen of the mobile device 103 accordingly to indicate the affirmative or negative response of the user 305. For example, if the third-party assistant recognizes that the user 305 signaled an affirmative response, the third-party assistant may tap the second portion 202 of the user interface 200 (e.g., checkmark) to display the “yes” indication of the user 305. If the third-party assistant recognizes that the user 305 signaled a negative response, the third-party assistant may tap the third portion 203 of the user interface 200 (e.g., square) to display the “no” indication of the user 305.

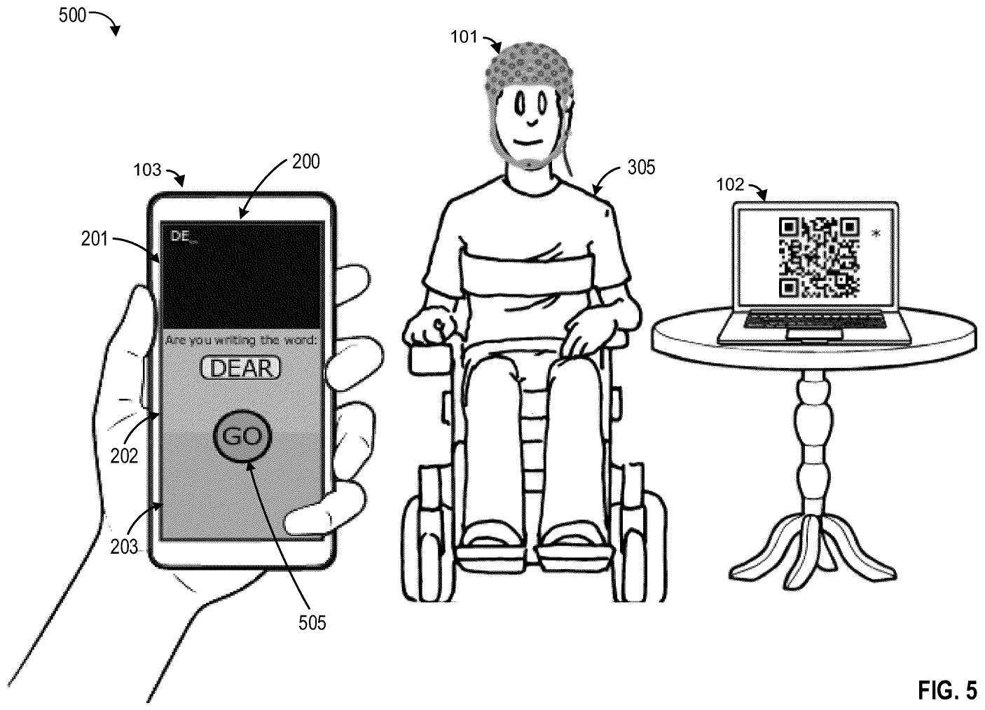

FIG. 5 is an example communication system 500, showing the interaction between various components designed to facilitate communication in automatic mode for a user 305 with a disability. The communication system 300 may comprise the assistive communication device 101, the computing device 102, and the mobile device 103. In the automatic mode, the user 305 may interact with the assistive communication device 101, using inputs such as neural signals, inhaling, or exhaling. The assistive communication device 101 may be a brain-computer interface (BCI) that detects neural signals corresponding to the intent of the user 305 to communicate specific letters or words, a sip-and-puff system that allows the user 305 to issue commands through inhaling or exhaling, and/or sensors. The assistive communication device 101 may communicate with the software on the computing device 102, ensuring that the selections of the user 305 with a disability are accurately captured and reflected in the text displayed on the screen.

The automatic mode may be initiated by pressing a button 505 (e.g., a “GO” button) at the appropriate time. The automatic mode may be initiated by the third-party assistant and/or the user 305 with the assistive communication device 101. The assistive communication device 101 (e.g., BCI, sensors, etc.) may infer and supply each “yes” or “no” answer to the computing device 102 and/or the mobile device 103. In the automatic mode, the computing device 102 may ask a systematic series of yes/no questions to the user 305 with a disability to determine the communication intent of the user 305. For example, a static grid arrangement of letters 400 as shown in FIG. 4 may be used by the computing device 102 to ask yes/no questions to the user 305. Specifically, the computing device 102 may display the yes/no questions to the user 305 with the static arrangement of letters 350 via the screen associated with the computing device 102. Each question may be one of three types: (1) offering a candidate group of letters (to be narrowed down by subsequent questions), (2) offering a final choice of letter (possibly including non-letter options such as “backspace” or “finish”), or (3) offering a possible word completion. Example questions and responses are described in the following interaction, in which the computing device 102 offers two groups of letters, then two letters, then a word completion: COMPUTING DEVICE: Do you want the first row? USER: No, COMPUTING DEVICE: Second? USER: Yes, COMPUTING DEVICE: [because the second row contains letters E through H followed by other options] Do you want the letter E? USER: No, COMPUTING DEVICE: F? USER: Yes, COMPUTING DEVICE: [because the letter F seems likely given previously-written words] Are you writing the word FIRST? USER: Yes.

Once the computing device 102 receives the inputs from the assistive communication device 101, the software on the computing device 102 may translate the inputs, which may include binary selections, or neural signals, into “yes” or “no” indications. Based on the “yes” or “no” indications, the computing device 102 may determine to send, to the mobile device 103, the letter or text that the user 305 answered to the yes/no questions. For example, if the user 305 signaled an affirmative response and the computing device determines that the signal from the user 305 is a “yes” indication, the computing device 102 may send the letter or text for which the user 305 is asked to display via the screen of the mobile device 103. For example, the first portion 201 of the user interface 200 may display the letter or text based on the “yes” indication. If the user 305 signaled a negative response and the computing device 102 determines that the signal from the user 305 is a “no” indication, the computing device 102 may neither send the letter or text for which the user 305 is asked, nor display the letter or text on the screen of the mobile device 103. When the computing device 102 determines that the signal from the user 305 is a “no” indication, the computing device 102 continue to display the yes/no questions to the user 305 with different letters or text.

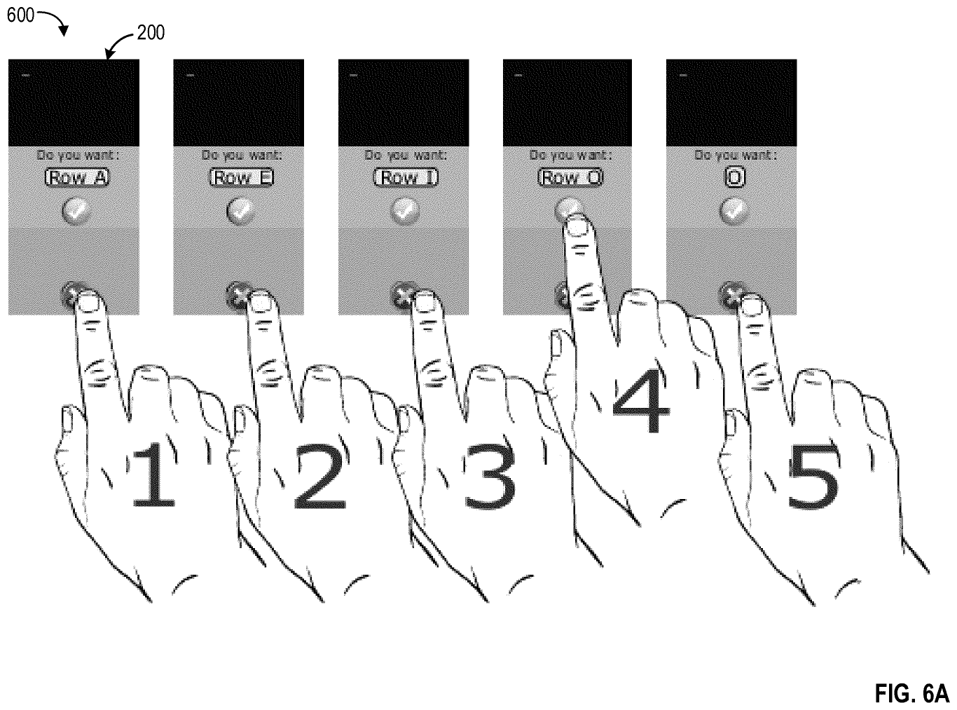

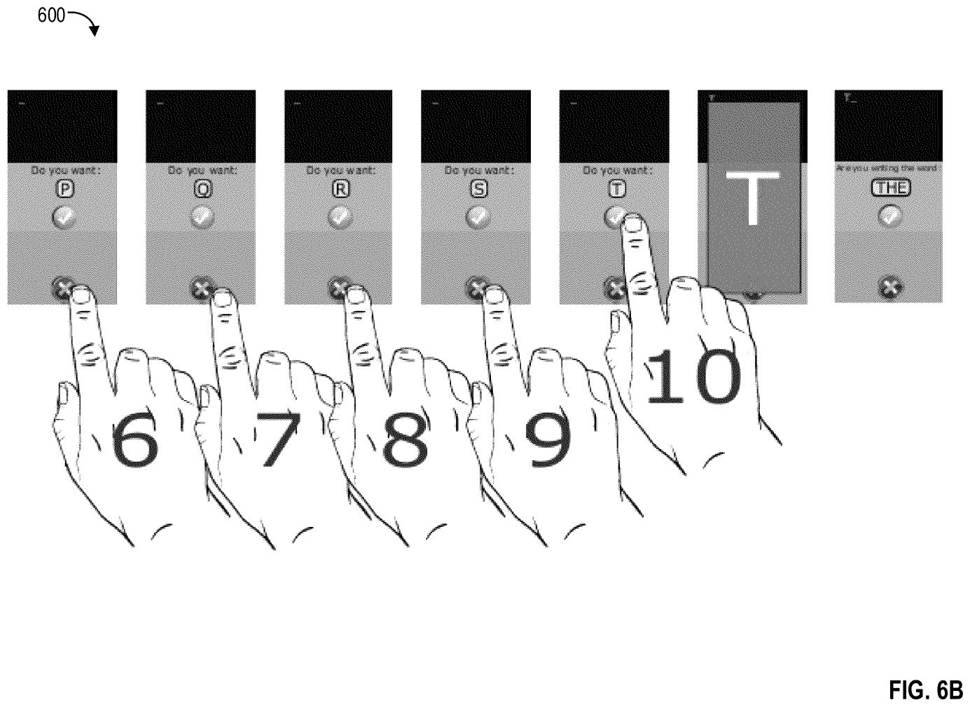

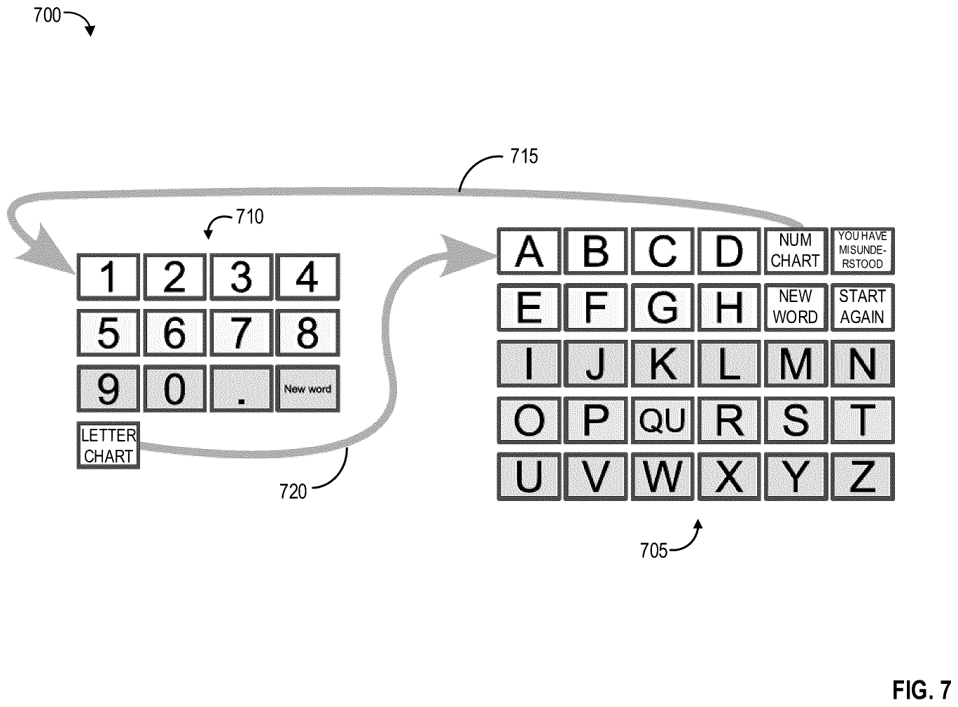

FIGS. 6A-B are an example sequence 600 of grid-scanning mode, showing the sequence of multiple responses in the grid-scanning mode entered by a third-party assistant via the mobile device 103. Without any alteration to the user interface 200, the software on the computing device 102 may be configured to offer character choices from a fixed grid 700 as shown in FIG. 7. Any grid arrangement is possible, including multiple grids hyperlinked to each other. For example, the fixed grid 700 in FIG. 7 may comprise a letter grid (or letter chart) 705 with a smaller number grid 710. Arrow 715 shows schematically the hyperlink effect of selecting the squares marked “Number chart.” Arrow 720 shows schematically the hyperlink effect of selecting the squares marked “Letter chart.” The grid-scanning mode may allow any set of grids to be configured. The backspace key may be offered whenever the user had rejected all rows of the current grid, and with additional probabilistically-driven offers of word suggestions and of the space character (the latter of which could also be typed explicitly by selecting “New word”).

Grid rows in the fixed grid 700 may be offered to the user with candidate sets of characters. For example, the question may appear as: “DO YOU WANT ONE OF: I, J, K, L, M, N.” Alternatively or additionally, to allow the procedure to go faster once the user has memorized the fixed grid 700, grid rows may be given arbitrary labels. For example, the question may appear as: “DO YOU WANT: ROW I”, “DO YOU WANT: THE THIRD ROW”, or “DO YOU WANT: BLUE ROWS”). Single characters may be offered. For example, the question may appear as: “DO YOU WANT: J.”

The basic sequence of yes/no decisions may be similar to the third party assisted-scanning. As shown in FIG. 6A, the first question may appear as: “DO YOU WANT: ROW I.” If a “no” response is received, the third-party assistant may tab a “no” button. The second question may then appear as: “DO YOU WANT: ROW E.” If a “no” response is received again, the third-party assistant may tab a “no” button again. The third question may appear as: “DO YOU WANT: ROW I.” If a “no” response is received, the third-party assistant may tab a “no” button. The fourth question may appear as: “DO YOU WANT: ROW O.” If a “yes” response is received, the third-party assistant may click a “yes” button. If a “yes” response is received following the offer of a row (e.g., ROW O), the individual characters of that row may be then offered in sequence until one is accepted. For example, the fifth question may appear as: “DO YOU WANT: O.” If a “no” response is received, the third-party assistant may click a “no” button. As shown in FIG. 6B, the sixth question may appear as: “DO YOU WANT: P.” If a “no” response is received, the third-party assistant may tab a “no” button and move the next question. The seventh question may appear as: “DO YOU WANT: Q.” If a “no” response is received, the third-party assistant may tab a “no” button and move the next question. The eighth question may appear as: “DO YOU WANT: R.” If a “no” response is received, the third-party assistant may tab a “no” button and move the next question. The ninth question may appear as: “DO YOU WANT: S.” If a “no” response is received, the third-party assistant may tab a “no” button and move the next question. The tenth question may appear as: “DO YOU WANT: T.” If a “yes” response is received, the third-party assistant may tab a “yes” button.

If none of the characters in that row is accepted, the software on the computing device 102 may revert to scanning through rows, to allow for the possibility that the row was selected in error. A “yes” answer to the offer of a character may result in that character being typed immediately as shown in FIG. 6B, and selection of the next character begins immediately, starting again at the first row. In addition, if all rows are rejected, the software on the computing device 102 may offer a backspace before starting again with the first row. Rows and characters may be selected by hard binarization of the yes/no inputs, regardless of whether the inputs come from a selection by the third-party assistant on the user interface 200 or from an automatic classifier. In case of the automatic classifier, any input p<0.5 may be considered a “no” response and any p>0.5 may be considered a “yes” response.

In the grid-scanning mode, the character prediction model may run in the background, and intervene to implement one specific exception. For example, the space character (regardless of whether it also appears explicitly on the grid) may be offered whenever the language model predicts it with a probability exceeding 0.4. Once offered, the response accepting or rejecting the space character may be binarized as described above. Additionally, word suggestions may also be offered via a separate mechanism.

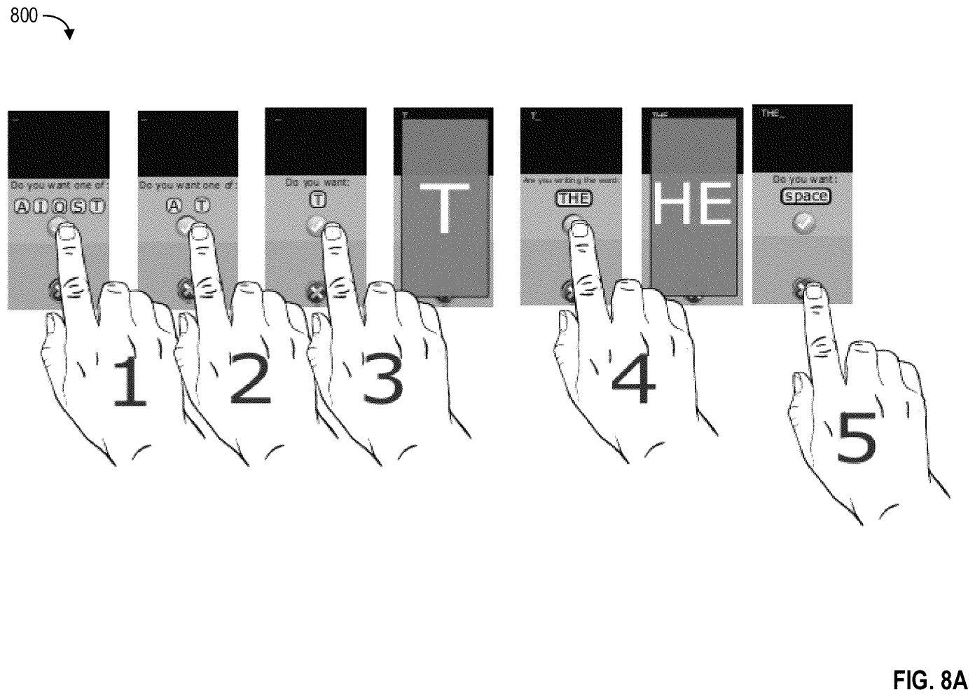

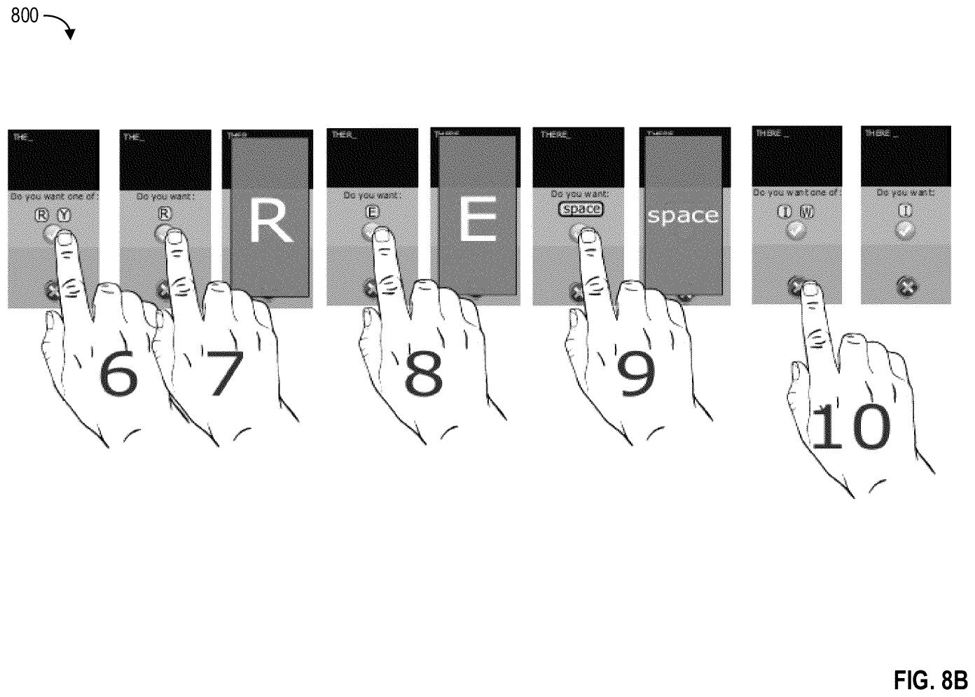

FIGS. 8A-B are an example sequence 800 of Bayesian mode, showing the sequence of multiple responses in the Bayesian mode entered by a third-party assistant via the mobile device 103. The Bayesian mode may comprise a Bayesian inference engine that guide the user through a binary decision tree to select each character. Cᵢ may be used to denote the hypothesis that a particular character (e.g., the i^{th} character in the character set) is the character that the user wants to type, and rⱼ to denote the observation of the j^{th} yes-or-no response of the user towards selecting the desired character. The inference engine may apply Bayes' rule to compute the posterior probability Pr (Cᵢ|rⱼ) for each possible Cᵢ, which is the degree of belief in Cᵢ for the system after having observed rⱼ:

$$Pr ( {C}_{i} \vert {r}_{j} ) = \frac{Pr ( {C}_{i} ) Pr ( {r}_{j} \vert {C}_{i} )}{Pr ( {r}_{j} )} \qquad Equation ( 1 )$$

In Equation (1), Pr (Cᵢ) is the prior probability (e.g., the degree of belief in Cᵢ for the system before rⱼ is observed). If there have been no responses yet pertaining to the current character, then Pr (Cᵢ) is obtained from a language model, as the predictive probability of Cᵢ given previously-typed characters. If the user has made responses to narrow down the choice of the current character, then Pr (Cᵢ) is equal to the posterior term Pr (Cᵢ|rⱼ−1) carried forward from the previous iteration. Since discrete probability distributions are used, the denominator Pr (r) may be the sum of numerator terms across all possible hypotheses Cᵢ, yielding the normalizing constant that ensures posterior probabilities sum to 1. The key term in transforming prior probabilities into posterior probabilities is the likelihood term Pr (Cᵢ|rⱼ): this term is the estimate of the probability that observation rⱼ would occur if Cᵢ were true, and its value is given according to the following four possibilities:

$$Pr ( {r}_{j} = “ no ” \vert {C}_{i} ) = \{ \begin{matrix}F \hat{N} R & if {C}_{i} was just offered \\ 1 - F \hat{P} R & if {C}_{i} was not offered\end{matrix} \qquad Equation ( 2 )$$

$$Pr ( {r}_{j} = “ yes ” \vert {C}_{i} ) = \{ \begin{matrix}1 - F \hat{N} R & if {C}_{i} was just offered \\ F \hat{P} R & if {C}_{i} was not offered\end{matrix} \qquad Equation ( 3 )$$

In Equations (2) and (3), F\hat{N}R (false negative rate) and F\hat{P}R (false positive rate) are the estimates by the system of the false negative rate and false positive rate, respectively. These may approximate the true FNR and FPR. The estimates of the false negative rate and false positive rate may always be non-zero, thereby preventing posterior probabilities from ever becoming zero. It is also possible to estimate F\hat{N}R and F\hat{P}R empirically, and to adapt these estimates over time, based on the outputs of the user. However, it may not be clear how to judge responses as correct or incorrect (and thereby identify false positives and false negatives) without knowing the intentions of the user in advance. In an example, the software on the computing device 102 may use a “one size fits all” estimate, F\hat{N}R=F\hat{P}R=0.01, when the inputs of the user are “hard” yesses and nos. For example, when they are input via the user interface 200 on the mobile device 103, and there is no information available about the certainty of classification of the yes/no response. Thus, the effect of the error rate may include the effects of a mismatch between the true and assumed rates.

Alternatively or additionally, the software on the computing device 102 may take its input from an automatic classifier. For example, the automatic classifier may classify input based on Electroencephalogram (EEG), Electromyography (EMG), and/or other biological signals, or classify input from a camera to detect blinks, eye movements or other facial movements. In this case it may be possible to use the output of the classifier to indicate a current estimate of the FNR or FPR. A probabilistic classifier (e.g., a logistic-regression classifier) outputs a predictive probability p, which is its best estimate of the probability that the incoming biological signal reflects the intention of the user to say “yes” rather than “no.” Clear signals, leading the classifier to be certain of its decision, may lead to p close to 0 (e.g., a clear “no”) or to 1 (e.g., a clear “yes”), whereas unclear noisy signals may lead to p closer to 0.5, reflecting the uncertainty for the classifier in its ability to interpret the input. If the classifier is well calibrated, this means that its estimates p are neither under-confident nor over-confident on average. In this case, a value of p<0.5 may be interpreted as “no, with F\hat{N}R=p and T\hat{N}R=1−p”, whereas a value p>0.5 can be interpreted as “yes, with T\hat{N}R=p and F\hat{P}R=1−p.”

In this case, Equations (2) and (3) may reduce to:

$$Pr ( {r}_{j} \vert {C}_{i} ) = \{ \begin{matrix}p & if {C}_{i} was just offered \\ 1 - p & if {C}_{i} was not offered\end{matrix} \qquad Equation ( 4 )$$

The software on the computing device 102 may use p*=max {0.01, min {0.99, p}} in Equation (4) instead of p.

To elicit each response, the software on the computing device 102 may offer a candidate set of characters and asks whether the desired character of the user is in that set. The screen associated with the mobile device 103 may display the prompt “DO YOU WANT ONE OF:” followed by the candidate characters (or simply “DO YOU WANT:” if there is only one character in the candidate set).

For example, as shown in FIG. 8A, the first question may appear as: “DO YOU WANT ONE OF: A, I, O, S, T.” If a “yes” response is received, the third-party assistant may tab a “yes” button. The number of characters may be reduced based on the Bayesian inference engine and the second question may appear as: “DO YOU WANT ONE OF: A, T.” If a “yes” response is received, the third-party assistant may tab a “yes” button. A character (e.g., T) may be selected based on the Bayesian inference engine and the third question may appear as: “DO YOU WANT: T.” If a “yes” response is received, the third-party assistant may tab a “yes” button. The “yes” answer to the offer of the character (e.g., T) may result in that character being typed immediately as shown in FIG. 8A. The language model or character prediction model may determine text or a word based on the selected character (e.g., T). The fourth question may then appear as: “DO YOU WANT THE WORD: THE.” If a “yes” response is received, the third-party assistant may tab a “yes” button. The “yes” answer to the offer of the word (e.g., THE) may result in that word being typed immediately as shown in FIG. 8A. The fifth question may appear as: “DO YOU WANT SPACE.” If a “no” response is received, the third-party assistant may tab a “no” button.

As shown in FIG. 8B, the software on the computing device 102 may offer another candidate set of characters based on the Bayesian inference engine and asks whether the desired character of the user is in that set. For example, the sixth question may appear as: “DO YOU WANT ONE OF: R, Y.” If a “yes” response is received, the third-party assistant may tab a “yes” button. The number of characters may be reduced based on the Bayesian inference engine and the seventh question may appear as: “DO YOU WANT: R.” If a “yes” response is received, the third-party assistant may tab a “yes” button. A character (e.g., E) may be selected based on the Bayesian inference engine and the eighth question may appear as: “DO YOU WANT: E.” If a “yes” response is received, the third-party assistant may tab a “yes” button. The ninth question may appear as: “DO YOU WANT SPACE.” If a “yes” response is received, the third-party assistant may tab a “yes” button. After the space is entered on the screen of the mobile device 103, the software on the computing device 102 may offer another candidate set of characters based on the Bayesian inference engine. For example, the tenth question may appear as: “DO YOU WANT ONE OF: I, W.” The software on the computing device 102 may proceed with a similar sequence of responses in the Bayesian mode until the desired text or words are determined.

In information-theoretic terms, the optimal candidate set may be formulated such that it represents exactly half of the prior probability distribution. In other words, the uncertainty about whether the user will respond “yes” or “no” may need to be maximized. By resolving as much uncertainty as possible with their next response, the user may provide maximal information. The software on the computing device 102 may perform this approximately. It may select characters for the candidate set greedily starting with the character with the highest Pr (Cᵢ), and continues adding the next-highest character, and the next, until their prior probabilities sum to 0.5 or higher, or until 6 characters have been reached, whichever comes first. While it may be possible to approach 0.5 more closely using a more-complicated selection mechanism, the user interface 200 on the mobile device 103 may be more pleasantly used if the most-probable characters were always explicitly offered, and if there were not too many of them to pay attention to.

The software on the computing device 102 may stop attempting to narrow the predictive distribution over characters when at least one response has been given towards the selection of the current character, the last response was a “yes,” and the posterior probability for one character exceeds 0.95 (e.g., in many cases, when a character has very high prior probability, all these criteria will be met following a single question and answer). The software on the computing device 102 may type the winning character, append it to the language model prompt, and consult the language model to obtain a new predictive distribution {Pr (Cᵢ)} for use as priors for the next character.

In parallel to the character prediction model, the software on the computing device 102 may also run a word prediction model. The word model may calculate a predictive distribution across words given previously typed words. If some characters of the current word have already been typed, this distribution may be narrowed down to include only the words that begin with the typed characters, and be then re-normalized. Word probabilities may be rounded to the nearest 0.01, and a shorter word may be preferred over a longer one with the same rounded probability. Whenever the top prediction exceeds a configurable probability threshold (e.g., set at 0.25 by default), it is offered as a whole-word suggestion like “IS THE NEXT WORD: THE” (e.g., if no characters have been typed), or as a suggested word completion like “ARE YOU WRITING THE WORD: THE” (e.g., if one or more characters have been typed).

Suggestions may be accepted or rejected with a single binarized response. In other words, even if the input comes from a probabilistic classifier, the input probability p may be binarized such that any p<0.5 is considered a rejection and any p≥0.5 is an acceptance. Accepted words may be typed immediately, but rejected words may not be offered again until after the next space character. Since word suggestions are an ancillary add-on to the main business of searching character by character, it is not critical for this part to obey Cromwell's rule. The space character may be usually offered immediately after a word suggestion is accepted, because it usually has a high probability at that point, but it is not automatically typed as part of the word. Thus, the user may be allowed to have the option of accepting a suggested word such as THE as a shortcut to faster completion of a longer word of which it is a sub-string, such as THERE.

In Bayesian mode, the backspace key may be offered after 4 consecutive “no” responses are received. In grid-scanning mode, the backspace may be offered after all rows of the grid have been rejected in turn (although the backspace option may also appear explicitly as an option in the grid itself).

When the user arrives at the backspace in Bayesian mode or grid-scanning mode, the software on the computing device 102 may first ask if the user wants to delete the last typed character. The response to this question may be binarized (e.g., any input value p<0.5 is considered a “no” and any p≥0.5 is considered a “yes”). If the answer is “no”, the software on the computing device 102 may revert to offering characters or sets of characters as before. If the answer is “yes,” the question may be repeated to confirm the deletion. A second consecutive “yes” may delete the character, and the software on the computing device 102 may then offer the possibility of going further and deleting the whole of the current (or previous) word. Two consecutive binarized “yes” answers may be required to accept word deletion. After deleting a word, normal character selection may be resumed. To delete a further word, the user may go through the above process (e.g., the whole 8-step process) again.

The character predictions and word predictions described above may both need a language model. The language model may be based on one of two approaches: N-gram and large-language-model (LLM). For example, the N-gram approach may instantiate large N-gram models with modified Kneser-Ney smoothing. For predicting characters, a 12-gram model may be trained on 21 billion characters of AAC-like text with a 34-character alphabet. A “huge” word model may be used to predict words. The “huge” word model may be a 4-gram model with a 100,000 word vocabulary, trained on 8.6 billion words.

The LLM approach may instantiate various generative pre-trained transformer models that predict the next multi-character token from the sequence of previous tokens. In this approach, a new prediction may be made each time a word ends. After each character, a copy of the predictive distribution may be created, narrowed to the subset of predictions that are compatible with the characters typed so far in the current word, and renormalized. For character prediction, the predictive distributions may be marginalized according to the character occupying the position in question. For word prediction, it may add a refinement to cope with the fact that transformer models generally break text into tokens that are sometimes word fragments rather than words. Thus, it may be necessary to run the model two or more times to obtain the sequence of tokens until a word boundary is encountered. If it is necessary to obtain a full predictive distribution across whole words, the time complexity of this exponentially growing tree of predictions would be prohibitive. However, since the software on the computing device 102 offers one word suggestion at a time, and only if its probability exceeds a threshold, it is feasible to ignore all predictions except the top-scoring one, and to extend it only if its score already exceeds the threshold.

Examples of the LLM may include, but are not limited to, GPT2, GPT2-xl, BLOOM-1b7, BLOOM-7b1, GPT2-pe and GPT2-ft. The gpt2 and gpt2-xl may be the smallest (e.g., with 124 million parameters) and largest (e.g., with 1.5 billion parameters) versions of the GPT-2 model, respectively. The BLOOM-1b7 and BLOOM-7b1 may be the 1.7 billion and 7.1 billion-parameter versions of BLOOM, respectively. GPT2-pe and GPT2-ft may be further variants of the GPT-2 model to explore the possible benefits of prompt engineering and fine-tuning, respectively.

In character prediction via either the LLM or N-gram approach, one or more characters may be completely absent from a particular prediction. In such cases, the software on the computing device 102 may not allow a character to have zero probability. For example, a small probability mass, equal to half the minimum non-zero probability already represented in the distribution, may be shared equally between any characters in the character set of the model that were not represented at all in the prediction, and the distribution may then be re-normalized. Adherence to not allowing a character to have zero probability may ensure, in Bayesian mode or Bayesian character searches, that even if a particular character is a-priori unlikely, or has been mistakenly rejected, it will still be offered again, sooner or later, if the user continues to reject the alternatives. In word prediction, zeros may not be corrected in a way similar to character prediction. However, zeros may be acceptable because word suggestion serves an optional, ancillary function in the speller. For example, even if the word prediction fails, it is still possible to spell any desired word letter-by-letter.

In an example, the system 300, 500 in FIGS. 3, 5, including the software on the computing device 102 may be connected to an automated system that is programmed to produce a given target text to test the efficiency of the system 300, 500, assess the benefits of different language models, and explore the effects of input error. Given N characters typed so far, the automated system may be aimed to say “yes” to any choice that would lead the (N+1)^{th} and subsequent characters to match the (N+1)^{th} and subsequent characters of the target text, and “no” to any choice that does not lead to this outcome.

The automated system may be programmed to commit random errors, at a separately-configured false positive rate (i.e., the error rate when the correct answer is “no”) and false negative rate (i.e., the error rate when the correct answer is “yes”). Inputs to the system may then take one of two forms: (1) the inputs may be a series of “hard” yes-or-no inputs with the configured error rates; or (2) the inputs may emulate a probabilistic classifier. In the latter case, for a given error rate e, we define z=Φ¹(1−ϵ), where Φ(·) is the cumulative normal distribution function, and draw a random sample x˜N(z, 1) if the correct answer is “yes” or x˜N(−z, 1) if the correct answer is “no.” The variate x may have the probability e of being on the wrong side of 0. The output p of the classifier may be given by the logistic function p=1/(1+e^{-2zx}) (e.g., x=0 maps to p=0.5). The balanced error rates (e.g., when the false positive rate and false negative rate are equal) may result in well-calibrated probabilities. With unbalanced error rates (e.g., when the false positive rate and false negative rate are not equal), this simulated classifier may not be well-calibrated. However, it may still be better than a “hard” yes-or-no classifier.

Any non-zero false positive rate may lead to erroneous outputs such as typos. Two possible responses to typos may be simulated: a perfectionist approach and a tolerant approach. In the perfectionist approach, the simulated user may attempt to decline all offers of characters and words in favor of the backspace and/or word-deletion options until the earliest typo has been removed. The word-deletion options may be accepted if more than two characters are still needed to be backspaced. It is noted that further characters can be typed in error while attempting to backspace due to false positive inputs. In the perfectionist approach, performance may be assessed by dividing the number of characters of the final correct output by the number of binary decisions taken to reach this goal, and multiplying by 100, to yield a “characters per 100 decisions” metric. This performance may reflect the efficiency of the interface from the point of view of a user for whom each decision costs precious time and energy. This performance may be a more relevant metric than any per-minute rate because: (1) any empirical time denominator may be dominated by arbitrary choices of simulated “overhead” (e.g., listening and thinking time) which in reality may vary widely from user to user; and (2) the absolute number of decisions may matter more than time, if each decision entails expenditure of the limited reserves of energy of the user.

In the tolerant approach, all typos may be left uncorrected. In other words, regardless of the content of the N characters already typed, the simulated user may continue to try to match the (N+1)^{th} character of the target text. It is noted that the language model predictions may be expected to degrade, because of errors in the prompt from which each prediction is made. Performance may be assessed simply by quantifying the percentage of characters that had been produced incorrectly once the target number of characters had been typed.

In example tests, the target may be a 426-word text consisting of the final 4 paragraphs of a scientific article. The test text may be automatically re-encoded into a 36-character alphabet comprising 26 letters, the space character, and 9 digits (e.g., the letter O performing double duty as a zero where necessary). As an additional option to improve the performance of a model, a further model variant (e.g., GPT-pe) may be created. The GPT-pe may be a small gpt2 model with a “prompt engineering” feature. For example, a short, fixed, generic scene-setting text may be prefixed to the GPT-pe model prompt before every prediction. In some examples, users may configure their models to prefix relevant background material such as their name, the names of their friends and family, their general situation, priorities, medical needs, level of education and/or the like. They may prime the LLM with a bias towards frequently-used vocabulary, names and grammatical constructions. For example, the GPT-pe model may be used with the following prefix: “I AM A US NEUROSCIENTIST AND NEURAL ENGINEER WHO WRITES ABOUT SYSTEMS FOR PROCESSING BIOSIGNALS LIKE EEG AND EMG IN REAL TIME. HERE IS WHAT I AM WRITING TODAY.”

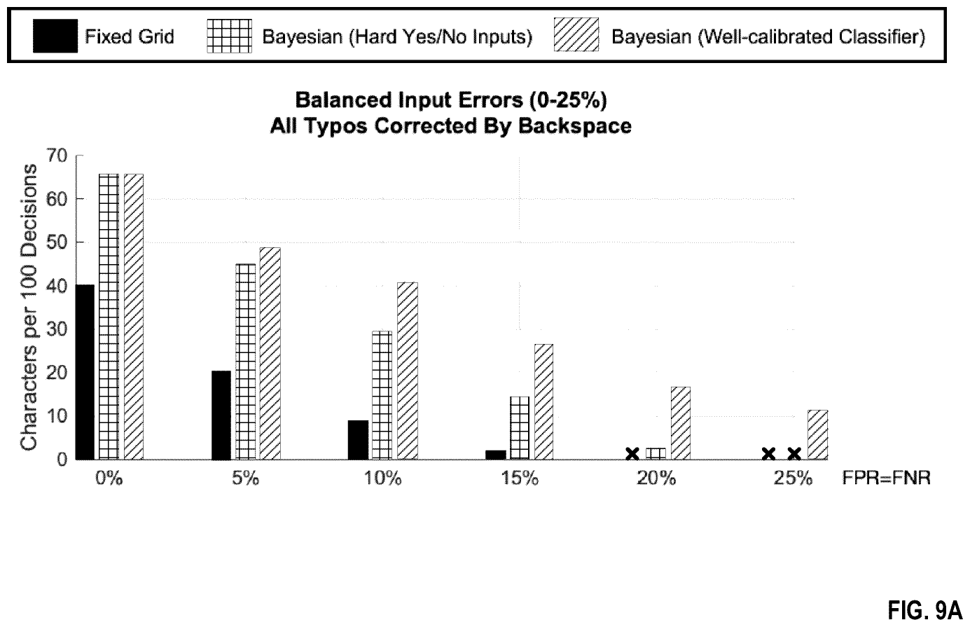

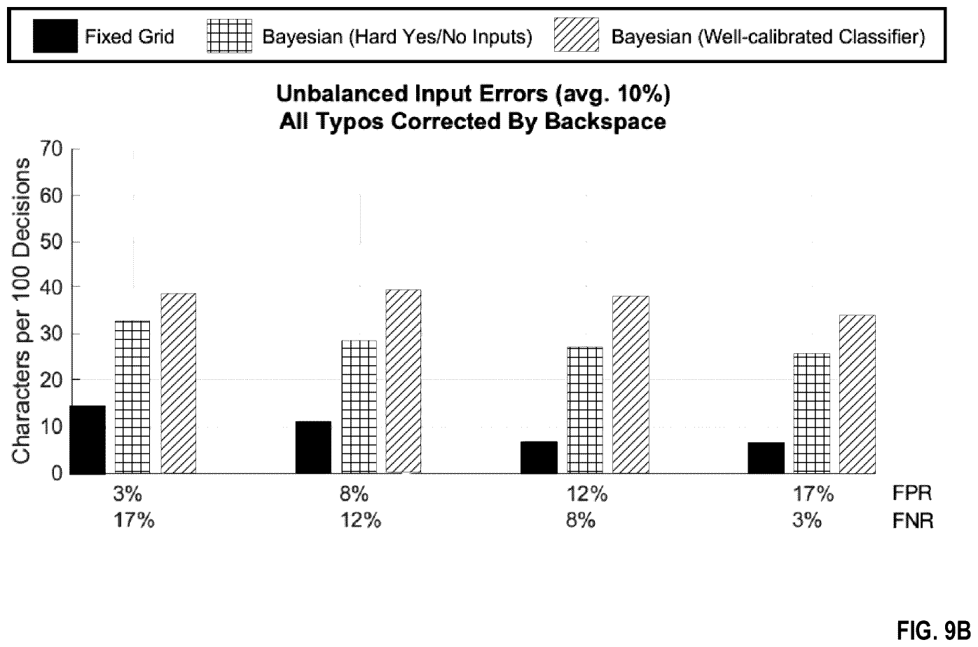

FIG. 9A is a diagram showing the effects of input error on speller performance in perfectionist mode where error rates are balanced. FIG. 9B is a diagram showing the effects of input error on speller performance in perfectionist mode where error rates are unbalanced. Specifically, FIG. 9A shows results for a range of input error rates, with FPR=FNR. FIG. 9B shows the results of unequal FPR and FNR, around a fixed balanced average error rate of 10%. The perfectionist mode may indicate that all typos are corrected by backspace. In FIGS. 9A, 9B, a gpt2 model is used for the language model. The word threshold may be set at 25%. The x-axis may represent input errors (i.e., FPR=false positive rate; FNR=false negative rate). The y-axis may represent speller speed/efficiency in characters per 100 decisions. The bars may represent a fixed grid approach, a Bayesian approach, and a well-calibrated classifier. An X may indicate an effective speed of 0. For example, the simulated user may generate typos faster than it could correct them. Thus, the simulated user may not finish the assignment.

As shown in FIG. 9A, with error-free inputs, the fixed grid approach achieved 40 characters per 100 decisions, which was slower than the 65 characters per 100 decisions using the Bayesian approach. When the input error rates are increased to 5%, the fixed grid speed fell 50%, while the Bayesian approaches with hard yes/no and well-calibrated inputs fell 31% and 26%, respectively. As the input error rates continued to increase, the gap between the fixed grid speller and Bayesian spellers widened. At FPR=FNR=10%, the fixed-grid speller had a speed of 8.8 characters per 100 decisions, while the Bayesian speller performed at 29.2 characters per 100 decisions with hard yes/no inputs, and 40.6 characters per 100 decisions with well-calibrated probabilistic inputs. When the input error rates reached 20%, the fixed grid speller generated typos faster than it could correct them. Thus, its efficiency became effectively zero as marked with an X in FIG. 9A. The Bayesian speller with hard yes/no inputs reached this threshold at 25% error, but with well-calibrated probabilistic inputs, it was still potentially usable even at these high input error rates at the reduced speed of 11.1 characters per 100 decisions. Thus, the Bayesian speller is functional at high levels of input error rates where the fixed grid approach is unusable. As shown in FIG. 9B, when observing the effects of unbalanced error rates around a balanced-average error rate of 10%, false positives had a greater impact than false negatives. However, this asymmetry may be more marked in the fixed grid than in the Bayesian spellers.

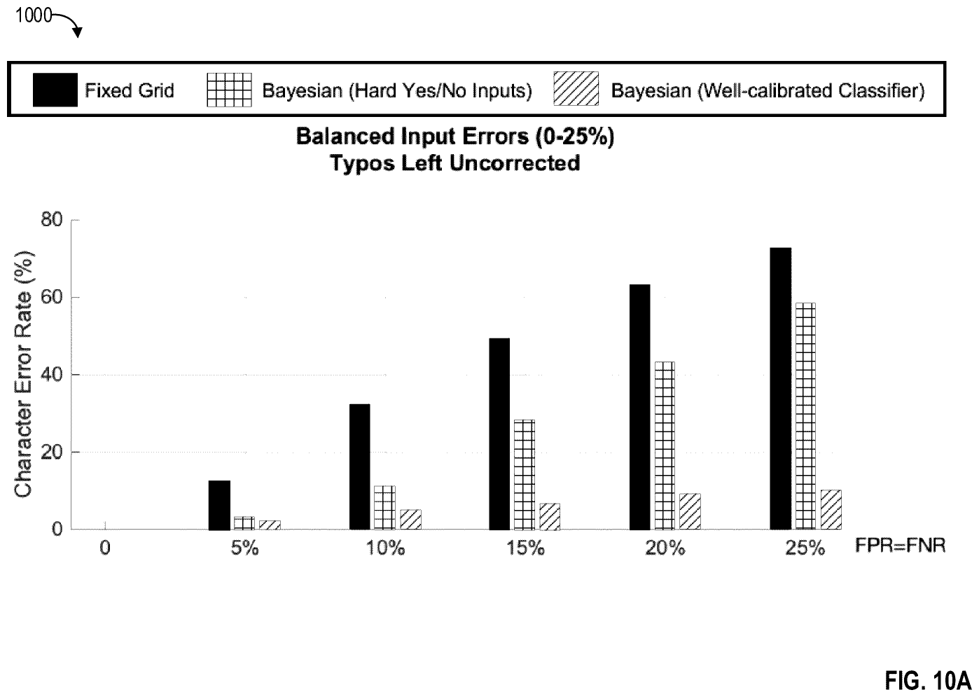

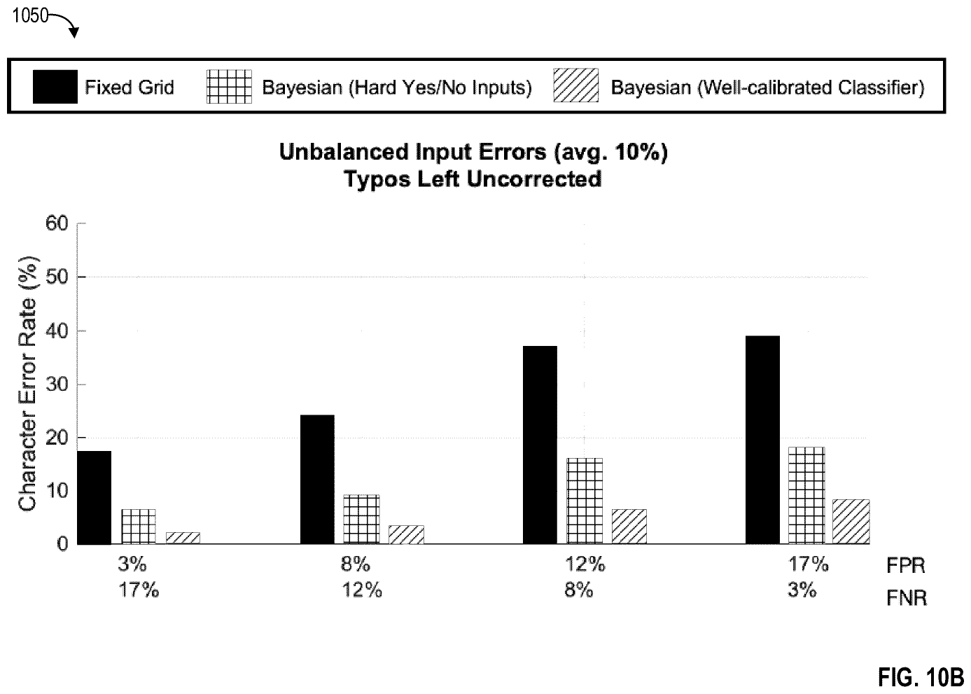

FIG. 10A is a diagram showing the effects of input error on speller accuracy in a tolerant mode where error rates are balanced. FIG. 10B is a diagram showing the effects of input error on speller accuracy in a tolerant mode where error rates are unbalanced. Specifically, FIG. 10A shows results for a range of input error rates, with FPR=FNR. FIG. 10B shows the results of unequal FPR and FNR, around a fixed balanced average error rate of 10%. Unlike the perfectionist mode indicating that all typos are corrected by backspace, the tolerant mode may indicate that typos are left uncorrected. In FIGS. 10A, 10B, a gpt2 model is used for the language model. The word threshold may be set at 25%. The x-axis may represent input errors (i.e., FPR=false positive rate; FNR=false negative rate). The y-axis may represent the percentage of incorrect characters. The bars may represent a fixed grid approach, a Bayesian approach, and a well-calibrated probabilistic classifier.

As shown in FIG. 10A, the fixed grid approach consistently exhibited a higher output error rate than its user input error rate. For example, when the user input error rate is 5%, the output error rate (or character output error rate) for the fixed grid approach is about 12%. However, a Bayesian well-calibrated classifier had a lower output error rate than its input error rate. For example, when the user input error rate is 20%, the output error rate (or character output error rate) for the Bayesian well-calibrated classifier is about 10%. Thus, the Bayesian well-calibrated classifier is less sensitive to the input error rates, as shown in FIG. 10A. Furthermore, as shown in FIG. 10B, worsening performance may be driven by false positive rates more than by false negative rates with unbalanced input error rates.

As shown in FIGS. 10A, 10B, target text rapidly became hard to understand once the character error rate exceeded about 10%. Table 1 shows example texts with different character error rates. The corresponding input error rates for each speller may be obtained by polynomial interpolation from the rates shown in FIGS. 10A, 10B, together with additional simulations near the points of interest. It is noted that the fixed grid approach reaches 10% character errors at an input error rate of only 5%. The Bayesian approach with “hard” yes/no inputs is more robust because it reaches the same output error level at 8% input error. Additionally, the output error level may be improved, at the expense of speed, by raising the presumed FNR and FPR. The Bayesian approach with a well-calibrated classifier tolerate input errors of up to 23% before the character error rate reaches 10%. The tolerance for the Bayesian approach with a well-calibrated classifier is 4.6 times higher than the fixed grid approach.

TABLE 1

| Input Error Rate | | | | |
|---|---|---|---|---|
| (FPR = FNR) | | | | |
| | Bayesian | Bayesian | Character | |
| Fixed Grid | (Hard Y/N) | (Calibrated) | Error Rate | Sample Output |
| 0% | 0% | 0% | 0% | IN ALL SUCH APPLICATIONS |
| | | | | THE ALGORITHM COULD |
| | | | | REDUCE THE TIME COST |
| | | | | COMPLEXITY AND |
| | | | | VARIABILITY ASSOCIATED |
| | | | | WITH HUMAN EXPERT |
| | | | | JUDGMENTS THUS IT HAS |
| | | | | GREAT POTENTIAL TO |
| | | | | ENABLE EFFECTIVE |
| | | | | TRANSLATION OF |
| | | | | RESEARCH PROTOCOLS |
| | | | | INTO CLINICAL USE |
| 1% | 4% | 6% | 2.5% | IN ALL SUCH APPLICATIONS |
| | | | | THE ALGORITHM COULD |
| | | | | REDUCE THE TIME COST OF |
| | | | | PLEXITY AND VARIABILITY |
| | | | | ASSOCIATED WITH HUMAN |
| | | | | EXPERT JUDGMENTS THUS |
| | | | | IT HAS GREAT POTENTIAL |
| | | | | TO ENABLE EFFECTIVE |
| | | | | TRANSLATION OF RE- |
| | | | | SEARCH PROTOCOLS INTO |
| | | | | CLINICAL APP |
| 3% | 5% | 12% | 5% | I WLL SUCH A PLIGATINS |
| | | | | THE ALGORI HM COULD |
| | | | | REDUCE THE TIME COST |
| | | | | COMPLEXITY AND |
| | | | | VARIABILITY ASSOCIATED |
| | | | | WITH HUMAN EXPOSURE |
| | | | | DGMENTS THUS IT HAS |
| | | | | GREAT POTENTIAL TO |
| | | | | ENABLE EFFECTIVE |
| | | | | TRANSLATION OF RE- |
| | | | | SEARCH PROTOCOLS INTO |
| | | | | CLINICAL USE |
| 4% | 7% | 18% | 7.5% | IN ALL SUCH APPLICATIONS |
| | | | | THE ALGORITHM COULD |
| | | | | REDUCE THE TIME COST |
| | | | | COMPLEXITY OFD |
| | | | | VARIABILITY ASSOCIATED |
| | | | | WITH HUMAN |
| | | | | EXPERIENCEG ENTI THUS |
| | | | | IT HAS GREAT POTENTIAL |
| | | | | TODAYABLE EFFECTIVE |
| | | | | TIMESLA ION OF RESEARCH |
| | | | | PROTOCOLS INTO |
| | | | | CAMNICAL USE |
| 5% | 8% | 23% | 10% | IN ALL SUCH APPLICATIONS |
| | | | | THE APPLICATIONOU D |
| | | | | REDUCE THE TIME COST |
| | | | | COMPAREDT AND |
| | | | | VARIANCEITY ASSOCIATED |
| | | | | WITH HUMAN BXP RT |
| | | | | JUDGMENTS THUS IT HAS |
| | | | | GREAT POTENTIAL TO |
| | | | | ENABLE EFFECTIVE |
| | | | | TRAISLA ION OF RE- |
| | | | | SEARCH PROTOCOLS INTO |
| | | | | CLINICAL ISE |
| Same output with 10% character error rate, corrected | | | | In all such applications, the |
| post-hoc by ChatGPT-3.5 | | | | application could reduce the time |
| | | | | cost compared to and variability |
| | | | | associated with human expert |
| | | | | judgments. Thus, it has great |
| | | | | potential to enable effective |
| | | | | translation of research protocols |
| | | | | into clinical use. |

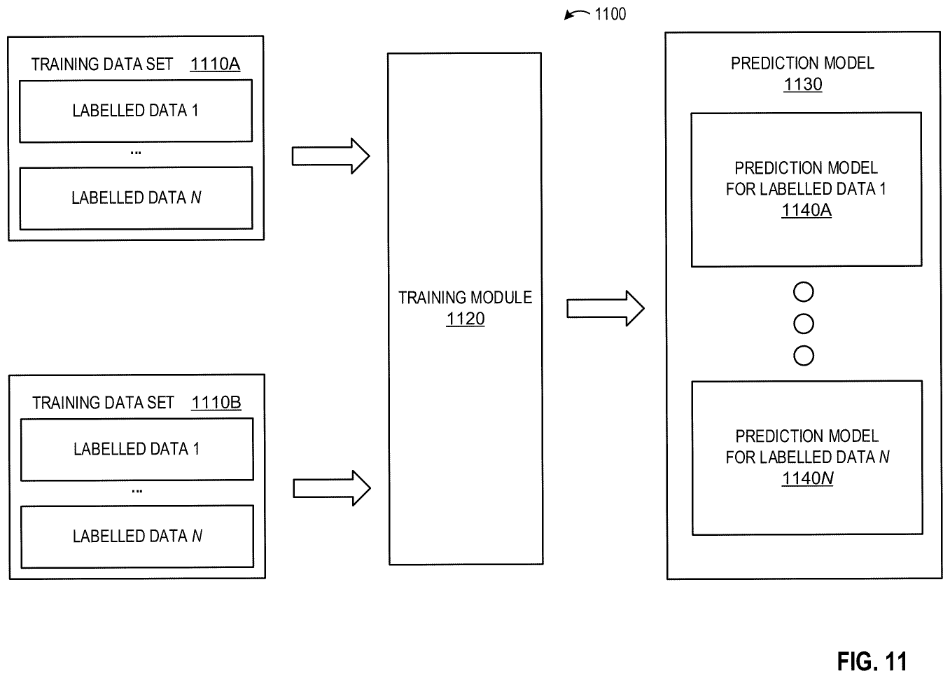

Turning now to FIG. 11, an example system 1100 for machine learning model training is shown. The system 1100 may be configured to use machine learning techniques to train, based on an analysis of a plurality of training datasets 1110A-1110B by a training module 1120, a prediction model 1130. Functions of the system 1100 described herein may be performed, for example, by the computing device 102, the server 104, and/or another computing device. The plurality of training datasets 1110A-1110B may be determined based on a large corpus of text data. For example, the plurality of training datasets 1110A-1110B may be gathered from books, articles, websites, and/or the like. Examples of the large corpus of text data include, but are not limited to, Wikipedia text consisting of 100 million characters, complete works of Shakespeare, email, Penn Treebank (PTB) including approximately 1 million words, and free books.

The training datasets 1110A, 1110B may be based on, or comprise, the data stored in the database of the computing device 102 and/or the server 104. Such data may be randomly assigned to the training dataset 1110A, the training dataset 1110B, and/or to a testing dataset. In some implementations, the assignment may not be completely random, and one or more criteria or methods may be used during the assignment. For example, the training dataset 1110A and/or the training dataset 1110B may be generated based on data collection and preprocessing. The preprocessing of the collected data may further comprise cleaning, tokenization, normalizing, and encoding. The cleaning process may remove noise such as HTML tags, special characters in the collected data, and correct any spelling errors. The tokenization may split the text into smaller units. For example, for character-level models, the text may be split into individual characters. For word-level models, the text may be split into words or subwords. The normalization may convert all text to lowercase, remove punctuation, or the like. The encoding process may convert tokens to numerical representations using methods like one-hot encoding, word embedding (e.g., Word2Vec, GloVe), or subword embedding (e.g., Byte-Pair Encoding). The text data collected from the large corpus of text data and preprocessed as described above may be randomly divided into training datasets and testing datasets. In general, any suitable method may be used to assign the text data to the training and/or testing datasets.

The training module 1120 may train the prediction model 1130 by determining/extracting the features from the training dataset 1110A and/or the training dataset 1110B in a variety of ways. For example, the training module 1120 may determine/extract features from the training dataset 1110A and/or the training dataset 1110B. As described above, the training dataset 1110A and/or the training dataset 1110B may be preprocessed by data cleaning, tokenization, encoding, sequence creation, one-hot encoding and/or word embedding to transform the text data into a suitable format for model training. The sequence creation may generate sequences of characters and the corresponding target character (e.g., the next character in the sequence). The one-hot encoding may convert integer indices to one-hot vectors if required by the prediction model. The word embedding may use pre-trained embedding (e.g., Word2Vec, GloVe) or train embedding during model training. The extracted features may be put together to train the prediction model 1130.

The training dataset 1110A and/or the training dataset 1110B may be analyzed to determine any dependencies, associations, and/or correlations between features in the training dataset 1110A and/or the training dataset 1110B. The identified correlations may have the form of a list of features that are associated with different labeled predictions. The term “feature,” as used herein, may refer to any characteristic of an item of text data that may be used to determine whether the item of text data falls within one or more specific categories or within a range. A feature selection technique may comprise one or more feature selection rules. The one or more feature selection rules may comprise a feature occurrence rule. The feature occurrence rule may comprise determining which features in the training dataset 1110A occur over a threshold number of times and identifying those features that satisfy the threshold as candidate features. For example, any features that appear greater than or equal to 5 times in the training dataset 1110A may be considered as candidate features. Any features appearing less than 5 times may be excluded from consideration as a feature. Other threshold numbers may be used as well.

A single feature selection rule may be applied to select features, or multiple feature selection rules may be applied to select features. The feature selection rules may be applied in a cascading fashion, with the feature selection rules being applied in a specific order and applied to the results of the previous rule. For example, the feature occurrence rule may be applied to the training dataset 1110A to generate a first list of features. A final list of candidate features may be analyzed according to additional feature selection techniques to determine one or more candidate feature groups (e.g., groups of features that may be used to determine a prediction). Any suitable computational technique may be used to identify the candidate feature groups using any feature selection technique such as filter, wrapper, and/or embedded methods. One or more candidate feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms used by the system 1100. Instead, features may be selected on the basis of scores in various statistical tests for their correlation with the outcome variable (e.g., a prediction).

As another example, one or more candidate feature groups may be selected according to a wrapper method. A wrapper method may be configured to use a subset of features and train the prediction model 1130 using the subset of features. Based on the inferences that may be drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate feature groups. Forward feature selection is an iterative method that begins with no features. In each iteration, the feature which best improves the model is added until an addition of a new variable does not improve the performance of the model. As another example, backward elimination may be used to identify one or more candidate feature groups. Backward elimination is an iterative method that begins with all features in the model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 1120 has generated a feature set(s), the training module 1120 may generate the prediction models 1140A-1140N based on the feature set(s). A machine learning-based prediction model (e.g., any of the prediction models 1140A-1140N) may refer to a complex mathematical model for the prediction of one or more characters, words, and/or language. The complex mathematical model for the prediction of one or more characters, words, and/or language may be generated using machine-learning techniques as described herein. For example, a machine learning-based prediction model may determine/predict the next character in a sequence, helping users by suggesting the next character they might want to say or type. The machine learning-based prediction model may suggest corrections for misspelled words based on character sequences, the next words to help users construct sentences quickly, common phrases based on the context of the input words, and/or complete sentences or phrases in a contextually appropriate manner.

By way of example, boundary features may be selected from, and/or represent the highest-ranked features in, a feature set. The training module 1120 may use the feature sets extracted from the training dataset 1110A and/or the training dataset 1110B to build the prediction models 1140A-1140N for the prediction of one or more characters, words, and/or language. In some examples, the prediction models 1140A-1140N may be combined into a single prediction model 1140. Similarly, the prediction model 1130 may represent a single model containing a single or a plurality of prediction models 1140 and/or multiple models containing a single or a plurality of prediction models 1140. It is noted that the training module 1120 may be part of a software module of the computing device 102 and/or a software module of the server 104. Examples of the prediction model 1130 or the prediction models 1140A-1140N may include, but are not limited to, Recurrent Neural Networks (RNNs), Long Short-Term Memory Networks (LSTMs), Gated Recurrent Units (GRUs), LSTM-based models, GRU-based models, Transformer-based models, GPT-2/GPT-3/GPT-4, Bidirectional Encoder Representations from Transformers (BERT), and Transformers.

The extracted features (e.g., one or more candidate features) may be combined in the classification models 1140A-1140N that are trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting classification model 1130 may comprise a decision rule or a mapping for each candidate feature in order to assign a prediction to a class.

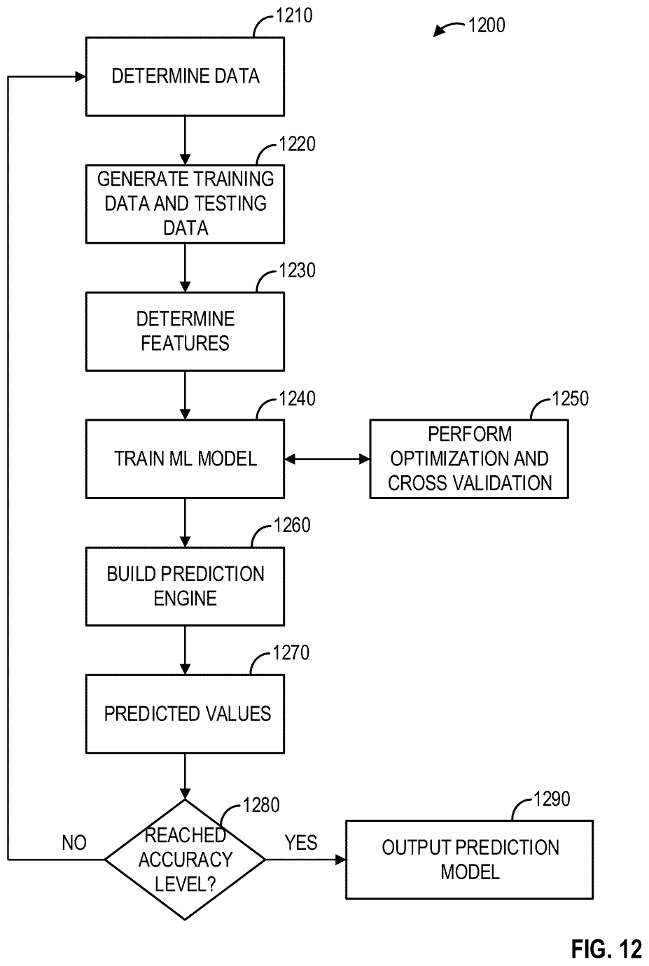

FIG. 12 is a flowchart illustrating an example training method 1200 for generating the prediction model 1130 using the training module 1120. The training module 1120 may implement supervised, unsupervised, and/or semi-supervised (e.g., reinforcement based) learning. The method 1200 illustrated in FIG. 12 is an example of a supervised learning method; variations of this example of training method may be analogously implemented to train unsupervised and/or semi-supervised machine learning models. The method 1200 may be implemented by any of the devices shown in any of the systems 100, 300, or 500. For example, the method 1200 may be part of a software module of the computing device 102 and/or a software module of the server 104.

At step 1210, the training method 1200 may determine (e.g., access, receive, retrieve, etc.) first training data and second training data (e.g., the training datasets 1110A-1110B). The first training data and the second training data may be determined from a large corpus of text data. For example, the plurality of training datasets 1110A-1110B may be gathered from books, articles, websites, and/or the like. The text data may be randomly divided into the first training data and the second training data. The training method 1200 may generate, at step 1220, a training dataset and a testing dataset. The training dataset and the testing dataset may be generated by randomly assigning data from the first training data and/or the second training data to either the training dataset or the testing dataset. For example, 70% of the data may be assigned to the first training dataset, and the remaining 30% may be assigned to the testing dataset. In some implementations, the assignment of data as training or test data may not be completely random.

The training method 1200 may determine (e.g., extract, select, etc.), at step 1230, one or more features that may be used for, for example, prediction of one or more characters, words, and/or language. The one or more features may comprise a set of features. As an example, the training method 1200 may determine a set of features from the first training data. As another example, the training method 1200 may determine a set of features from the second training data. The features from the text data may be determined based on preprocessing the text data. The preprocessing of the data may comprise cleaning, tokenization, normalizing, and encoding. The cleaning process may remove noise such as HTML tags, special characters in the collected data, and correct any spelling errors. The tokenization may split the text into smaller units. For example, for character-level models, the text may be split into individual characters. For word-level models, the text may be split into words or subwords. The normalization may convert all text to lowercase, remove punctuation, or the like. The encoding process may convert tokens to numerical representations using methods like one-hot encoding, word embedding (e.g., Word2Vec, GloVe), or subword embedding (e.g., Byte-Pair Encoding). The text data collected/preprocessed from the large corpus of text data may be randomly divided into training datasets and testing datasets.

The training method 1200 may train one or more machine learning models (e.g., one or more classification models, one or more prediction models, neural networks, deep-learning models, etc.) using one or more features at step 1240. In one example, the machine learning models may be trained using supervised learning. In another example, other machine learning techniques may be used, including unsupervised learning and semi-supervised. The machine learning models trained at step 1240 may be selected based on different criteria depending on the problem to be solved and/or data available in the training dataset. For example, machine learning models may suffer from different degrees of bias. Accordingly, more than one machine learning model may be trained at 1240, and then optimized, improved, and cross-validated at step 1250.

The training method 1200 may select one or more machine learning models to build the prediction model 1130 at step 1260. The prediction model 1130 may be evaluated using the testing dataset. The prediction model 1130 may analyze the testing dataset and generate prediction values (e.g., values indicating one or more of next characters, words, and/or language) at step 1270. Prediction values may be evaluated at step 1280 to determine whether such values have achieved the desired accuracy level. Performance of the prediction model 1130 may be evaluated in a number of ways based on a number of true positives, false positives, true negatives, and/or false negatives classifications of the plurality of data points indicated by the classification model 1130. Related to these measurements are the concepts of recall and precision. Generally, recall refers to a ratio of true positives to a sum of true positives and false negatives, which quantifies a sensitivity of the classification/prediction model 1130. Similarly, precision may refer to a ratio of true positives, a sum of true and false positives. When such a desired accuracy level is reached, the training phase ends and the prediction model 1130 may be output at step 1290; when the desired accuracy level is not reached, however, then a subsequent iteration of the training method 1200 may be performed starting at step 1210 with variations such as, for example, considering a larger collection of text data. The prediction model 1130 may be output at step 1290.

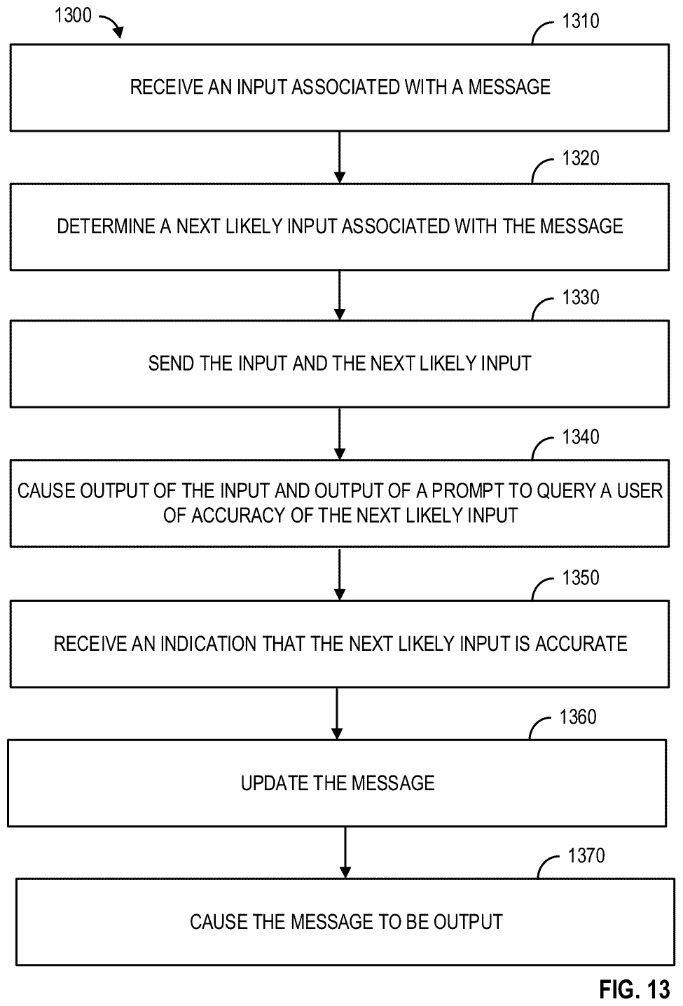

FIG. 13 shows an example method 1300 for enhancing user interaction with assistive technology. The method 1300 may be performed by any device, such as the computing device 102, the mobile device 103 (or a user device of a third party assistant), or the server 104. At 1310, an input associated with a message may be received. For example, the computing device 102 may receive the input associated with the message from an assistive communication device 101. The input received from the assistive communication device 101 may comprise or indicate one or more of a letter (or a character), a word, or a phrase. In an example, the computing device 102 may receive a signal indicative of the input from the assistive communication device 101. The signal may comprise one or more of a binary selection, a muscle twitch, an eye movement, a body movement, a gesture, a voice, or neural signals. The computing device 102 may translate the signal received from the assistive communication device 101 into the input comprising one or more of a letter, a word, or a phrase. In another example, the assistive communication device 101 may receive the signal indicative of one or more of a letter, a word, or a phrase and send the signal to the computing device 102 as the input. In another example, the assistive communication device 101 may receive the signal from a user with a disability and translate the signal into the input comprising one or more of a letter, a word, or a phrase. The assistive communication device 101 may send the input to the computing device 102.

The computing device 102 may include a communication interface such as a Bluetooth module, a cellular module, a Wi-Fi module, a Zigbee module, an NFC module, or any other short/long range communication module to communicate with external devices such as the assistive communication device 101, the mobile device 103, the user device, the server 104, and/or the network 105. The computing device 102 may be configured to display a machine-readable symbol, such as a QR code, bar code, another 2-dimensional code, a URL, or other type of symbol that can be scanned or accessed by the mobile device 103 or the user device. The symbol or URL may serve as a gateway for the mobile device 103 or the user device to establish a secure connection with the computing device 102 and/or the server 104.

The assistive communication device 101 may serve as the primary input mechanism to receive a signal indicative of the input from the user with a disability, which may operate in several modes to accommodate different types of disabilities and user preferences. Examples of the assistive communication device 101 may include, but are not limited to, a brain-computer interface, a muscle movement sensor, an eye-direction detector, a sip-and-puff system, a switch-based device, a voice-activated system, a specialized joystick, an adaptive keyboard, and a foot pedal. The signal received from the assistive communication device 101 may comprise one or more of a binary selection, a muscle twitch, an eye movement, a body movement, a gesture, a voice, or neural signals. The signal, input, or message may comprise one or more of a word, a partial word, a letter, or a sentence that the user desires to spell.

At 1320, a next likely input associated with the message may be determined. The next likely input may comprise one or more of a letter, a word, punctuation, or a phrase. For example, the computing device 102 or the server 104 may determine the next likely input associated with the message. The next likely input may be determined based on one or more of an alphabetical grid, a Bayesian mode, or a large language model. The next likely input may also be determined based on a machine-learning model. For example, the computing device 102 may determine the next likely input based on the alphabetical grid using the grid-scanning mode as described in FIGS. 6A-B. For example, the computing device 102 may determine the next likely input based on the Bayesian mode as described in FIGS. 8A-B. In another example, the computing device 102 may determine the next likely input based on one or more language models such as the N-gram model and the large language model (LLM) as described above. In another example, the computing device 102 may determine the next likely input based on one or more machine learning models as described in FIGS. 11-12. Examples of the machine learning model and/or the language model may include, but are not limited to, Recurrent Neural Networks (RNNs), Long Short-Term Memory Networks (LSTMs), Gated Recurrent Units (GRUs), LSTM-based models, GRU-based models, Transformer-based models, GPT-2/GPT-3/GPT-4, Bidirectional Encoder Representations from Transformers (BERT), T5, and Transformers.

At 1330, the input associated with the message and the next likely input associated with the message may be sent. For example, the computing device 102 may send the input associated with the message and the next likely input associated with the message to the mobile device 103 or the user device via a secure communication session. The secure communication session may be established by causing, at the computing device 102, a display of a symbol, receiving an indication that the mobile device 103 or the user device has detected the symbol, and initiating, based on the indication, the secure communication session with the mobile device 103 or the user device. For example, the mobile device 103 or the user device associated with a third-party assistant may scan the machine-readable symbol, such as a QR code, bar code, another 2-dimensional code, a URL or other type of symbol that can be scanned or accessed by the mobile device 103 or the user device. The machine-readable symbol may serve as a gateway for the mobile device 103 or the user device to establish the secure connection with the computing device 102. The third-party assistant may be a conversation partner, a human communication partner, a family member, a medical professional, and/or the like. In an example, the secure communication session may be one of a direct communication session between the computing device 102 and the user device (or the mobile device 103) or via the server 104.

At 1340, the output of the input associated with the message and the output of a prompt to query the user of the assistive communication device 101 of the accuracy of the next likely input associated with the message may be caused. For example, the computing device 102 may cause, via the secure communication session, the output of the input associated with the message and the output of a prompt to query a user of the assistive communication device 101 of the accuracy of the next likely input associated with the message. For example, the computing device 102 may cause the output of the input associated with the message and the output of the prompt to query a user of the assistive communication device 101 of the accuracy of the next likely input associated with the message at the mobile device 103 or the user device. For example, the mobile device 103 or the user device that established the secure compunction session with the computing device 102 may display the output of the input associated with the message and the output of a prompt to query the user of the assistive communication device 101 about the accuracy of the next likely input. For example, the prompt to query a user of the assistive communication device 101 of the accuracy of the next likely input associated with the message may comprises the determined next likely input associated with the message. For example, the input associated with the message may be displayed on the first portion 201 of the user interface 200 in FIG. 2. Assuming that the next likely input determined by the computing device 102 is ‘J,’ the query may appear as: “DO YOU WANT: J.” The prompt may comprise one or more of a “yes” indicator or a “no” indicator. The “yes” indicator may be or comprise a checkmark, as shown in FIG. 2. The “no” indicator may be or comprise a square or an X mark, as shown in FIG. 2. For example, the “yes” indicator and the “no” indicator may be used/displayed in the manual mode described above. The prompt may comprise a “go” indicator. The “go” indicator may be a button, as shown in FIG. 5. The “go” indicator may be used/displayed in the automatic mode described above. For example, the assistive communication device 101 may comprise a brain-computer interface (BCI). Once the “go” indicator is depressed or enabled, the indication of whether the next likely input associated with the message is accurate may be automatically received by the computing device 102 or the mobile device 103 via the BCI.

At 1350, an indication that the next likely input associated with the message is accurate may be received. For example, the computing device 102 may receive, via the secure communication session, the indication that the next likely input associated with the message is accurate. For example, in the manual mode, the computing device 102 may receive the indication from the mobile device 103 or the user device via the secure communication session. For example, the indication may be received based on the “yes” indicator being depressed or enabled at the mobile device 103 or the user device. In the automatic mode, the computing device 102 may receive the indication directly from the assistive communication device 101. For example, the assistive communication device 101 may detect the indication from the user 305 and send the indication to the computing device 102.

An indication that the next likely input associated with the message is not accurate may be received. For example, the computing device 102 may receive, via the secure communication session, the indication that the next likely input associated with the message is not accurate. For example, in the manual mode, the computing device 102 may receive the indication from the mobile device 103 or the user device via the secure communication session. For example, the indication may be received based on the “no” indicator being depressed or enabled at the mobile device 103 or the user device. In the automatic mode, the computing device 102 may receive the indication directly from the assistive communication device 101. For example, the assistive communication device 101 may detect the indication from the user 305 and send the indication to the computing device 102.

Once the computing device 102 receives, via the secure communication session, the indication that the next likely input associated with the message is not accurate, the computing device 102 or the server 104 (via the communication with the computing device 102) may determine another next likely input associated with the message. Another next likely input may be determined based on one or more of an alphabetical grid, a Bayesian mode, a large language model, or a machine-learning model as described above. For example, the computing device 102 may cause, via the secure communication session, the output of the input associated with the message and the output of a prompt to query a user of the assistive communication device 101 of the accuracy of another next likely input associated with the message at the mobile device 103 or the user device. The computing device 102 may receive, via the secure communication session, another indication that another next likely input associated with the message is accurate or not.

At 1360, the message may be updated. For example, the computing device 102 may update the message based on the next likely input associated with the message. For example, the computing device 102 may update the message based on the indication of the next likely input associated with the message. The indication of the next likely input may comprise a plurality of letters. A portion of the plurality of letters may be determined as a next letter to be added to the message. For example, the computing device 102 may determine, based on the indication, the portion of the plurality of letters as the next letter to be added to the message. The output of the portion of the plurality of letters may be caused or displayed, via the secure communication session, on the user interface (e.g., user interface 200) of the mobile device 103 or the user device. An indication that the portion of the plurality of letters comprises the next letter to be added to the message may be received via the secure communication session. For example, the computing device 102 may receive the indication that the portion of the plurality of letters comprises the next letter from the mobile device 103, the user device, and/or the assistive communication device 101 to be added to the message. The message may be updated by adding the next letter to the message.

At 1370, the message may be caused to be output. For example, the computing device 102 may cause the mobile device 103 or the user device to output the message. For example, the message may be output or displayed via the user interface (e.g., user interface 200) of the mobile device 103 or the user device.

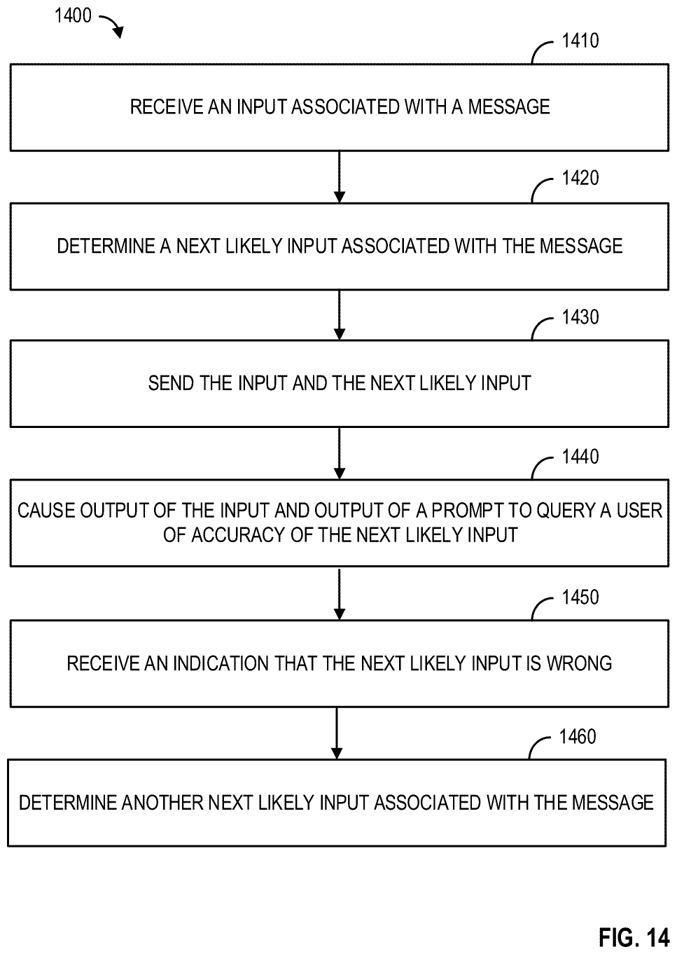

FIG. 14 shows an example method 1400 for enhancing user interaction with assistive technology. The method 1400 may be performed by any device, such as the computing device 102, the mobile device 103 (or a user device of a third party assistant), or the server 104. At 1410, an input associated with a message may be received. For example, the computing device 102 may receive the input associated with the message from an assistive communication device 101. The input received from the assistive communication device 101 may comprise or indicate one or more of a letter (or a character), a word, or a phrase. In an example, the computing device 102 may receive a signal indicative of the input from the assistive communication device 101. The signal may comprise one or more of a binary selection, a muscle twitch, an eye movement, a body movement, a gesture, a voice, or neural signals. The computing device 102 may translate the signal received from the assistive communication device 101 into the input comprising one or more of a letter, a word, or a phrase. In another example, the assistive communication device 101 may receive the signal indicative of one or more of a letter, a word, or a phrase and send the signal to the computing device 102 as the input. In another example, the assistive communication device 101 may receive the signal from a user with a disability and translate the signal into the input comprising one or more of a letter, a word, or a phrase. The assistive communication device 101 may send the input to the computing device 102.

The computing device 102 may include a communication interface such as a Bluetooth module, a cellular module, a Wi-Fi module, a Zigbee module, an NFC module, or any other short/long range communication module to communicate with external devices such as the assistive communication device 101, the mobile device 103, the user device, the server 104, and/or the network 105. The computing device 102 may be configured to display a machine-readable symbol, such as a QR code, bar code, another 2-dimensional code, a URL or other type of symbol that can be scanned or accessed by the mobile device 103 or the user device. The symbol or URL may serve as a gateway for the mobile device 103 or the user device to establish a secure connection with the computing device 102 and/or the server 104.

The assistive communication device 101 may serve as the primary input mechanism to receive a signal indicative of the input from the user with a disability, which may operate in several modes to accommodate different types of disabilities and user preferences. Examples of the assistive communication device 101 may include, but are not limited to, a brain-computer interface, a muscle movement sensor, an eye-direction detector, a sip-and-puff system, a switch-based device, a voice-activated system, a specialized joystick, an adaptive keyboard, and a foot pedal. The signal, input, or message may comprise one or more of a word, a partial word, a letter, or a sentence that the user desires to spell.

At 1420, a next likely input associated with the message may be determined. The next likely input may comprise one or more of a letter, a word, punctuation, or a phrase. For example, the computing device 102 or the server 104 may determine the next likely input associated with the message. The next likely input may be determined based on one or more of an alphabetical grid, a Bayesian mode, or a large language model. The next likely input may also be determined based on a machine-learning model. For example, the computing device 102 may determine the next likely input based on the alphabetical grid using the grid-scanning mode as described in FIGS. 6A-B. In another example, the computing device 102 may determine the next likely input based on the Bayesian mode as described in FIGS. 8A-B. In another example, the computing device 102 may determine the next likely input based on one or more language models such as the N-gram model and the large language model (LLM) as described above. In another example, the computing device 102 may determine the next likely input based on one or more machine learning models as described in FIGS. 11-12.

At 1430, the input associated with the message and the next likely input associated with the message may be sent. For example, the computing device 102 may send the input associated with the message and the next likely input associated with the message to the mobile device 103 or the user device via a secure communication session. The secure communication session may be established by causing, at the computing device 102, a display of a symbol, receiving an indication that the mobile device 103 or the user device has detected the symbol, and initiating, based on the indication, the secure communication session with the mobile device 103 or the user device. For example, the mobile device 103 or the user device associated with a third-party assistant may scan the machine-readable symbol, such as a QR code, bar code, another 2-dimensional code, a URL or other type of symbol that can be scanned or accessed by the mobile device 103 or the user device to establish the secure connection with the computing device 102. In an example, the secure communication session may be one of a direct communication session between the computing device 102 and the user device (or the mobile device 103) or via the server 104.

At 1440, the output of the input associated with the message and the output of a prompt to query the user of the assistive communication device 101 of the accuracy of the next likely input associated with the message may be caused. For example, the computing device 102 may cause, via the secure communication session, the output of the input associated with the message and the output of a prompt to query a user of the assistive communication device 101 of the accuracy of the next likely input associated with the message. For example, the computing device 102 may cause the output of the input associated with the message and the output of the prompt to query a user of the assistive communication device 101 of the accuracy of the next likely input associated with the message at the mobile device 103 or the user device. For example, the mobile device 103 or the user device that established the secure compunction session with the computing device 102 may display the output of the input associated with the message and the output of a prompt to query the user of the assistive communication device 101 about the accuracy of the next likely input. For example, the prompt to query a user of the assistive communication device 101 of the accuracy of the next likely input associated with the message may comprises the determined next likely input associated with the message. The prompt may comprise one or more of a “yes” indicator or a “no” indicator as shown in FIG. 2. For example, the “yes” indicator and the “no” indicator may be used/displayed in the manual mode described above. The prompt may comprise a “go” indicator, as shown in FIG. 5. The “go” indicator may be used/displayed in the automatic mode described above. For example, the assistive communication device 101 may comprise a brain-computer interface (BCI), and once the “go” indicator is depressed or enabled, the indication whether the next likely input associated with the message is accurate is automatically received by the computing device 102 or the mobile device 103 via the BCI.

At 1450, an indication that the next likely input associated with the message is wrong may be received. For example, the computing device 102 may receive, via the secure communication session, the indication that the next likely input associated with the message is wrong. In the manual mode, the computing device 102 may receive the indication from the mobile device 103 or the user device via the secure communication session. For example, the indication may be received based on the “no” indicator being depressed or enabled at the mobile device 103 or the user device. In the automatic mode, the computing device 102 may receive the indication directly from the assistive communication device 101. For example, the assistive communication device 101 may detect the indication from the user 305 and send the indication to the computing device 102.

An indication that the next likely input associated with the message is accurate may be received. For example, the computing device 102 may receive, via the secure communication session, the indication that the next likely input associated with the message is accurate. For example, in the manual mode, the computing device 102 may receive the indication from the mobile device 103 or the user device via the secure communication session. For example, the indication may be received based on the “yes” indicator being depressed or enabled at the mobile device 103 or the user device. In the automatic mode, the computing device 102 may receive the indication directly from the assistive communication device 101. For example, the assistive communication device 101 may detect the indication from the user 305 and send the indication to the computing device 102. Once the computing device 102 receives, via the secure communication session, the indication that the next likely input associated with the message is accurate, the computing device 102 may cause, via the secure communication session, the output of the input associated with the message and the output of a prompt to query a user of the assistive communication device 101 of the accuracy of the next likely input associated with the message.

At 1460, another next likely input associated with the message may be determined. For example, if the computing device 102 receives, via the secure communication session, the indication that the next likely input associated with the message is wrong, the computing device 102 may determine another next likely input associated with the message. Similar to the next likely input described above, another next likely input may comprise one or more of a letter, a word, punctuation, or a phrase. For example, the computing device 102 may determine another next likely input associated with the message based on one or more of an alphabetical grid, a Bayesian mode, a large language model, or a machine-learning model. In an example, the computing device 102 may use the grid-scanning mode to determine another next likely input based on the alphabetical grid as described in FIGS. 6A-B. In another example, the computing device 102 may use the Bayesian mode to determine another next likely input as described in FIGS. 8A-B. In another example, the computing device 102 may use one or more language models to determine another next likely input. The language model may be an N-gram model and a large language model (LLM) as described above. In another example, the computing device 102 may use one or more machine learning model to determine another next likely input as described in FIGS. 11-12.

Once another next likely input associated with the message is determined, another next likely input associated with the message may be sent. For example, the computing device 102 may send another next likely input associated with the message to the mobile device 103 or the user device via the secure communication session established between the computing device 102 and the mobile device 103 or between the computing device 102 and the user device. The output of a second prompt to query the user of the assistive communication device 101 of the accuracy of another next likely input associated with the message may be caused. For example, the computing device 102 may cause, via the secure communication session, the output of the second prompt to query the user of the assistive communication device 101 of the accuracy of another next likely input associated with the message. For example, the mobile device 103 or the user device may display the output of the second prompt to query the user of the assistive communication device 101 about the accuracy of another next likely input. The second prompt may comprise one or more of a “yes” indicator or a “no” indicator. The “yes” indicator and the “no” indicator may be used/displayed in the manual mode described above. The prompt may comprise a “go” indicator. The “go” indicator may be used/displayed in the automatic mode described above.

An indication that another next likely input associated with the message is accurate may be received. For example, the computing device 102 may receive, via the secure communication session, the indication that another next likely input associated with the message is accurate. The message may be updated based on another next likely input. For example, the computing device 102 may update the message based on another next likely input associated with the message. For example, the computing device 102 may update the message based on the indication of another next likely input associated with the message. The message may be caused to be output. For example, the computing device 102 may cause the mobile device 103 or the user device to output or display the message. The message may be output or displayed via the user interface (e.g., user interface 200) of the mobile device 103 or the user device.

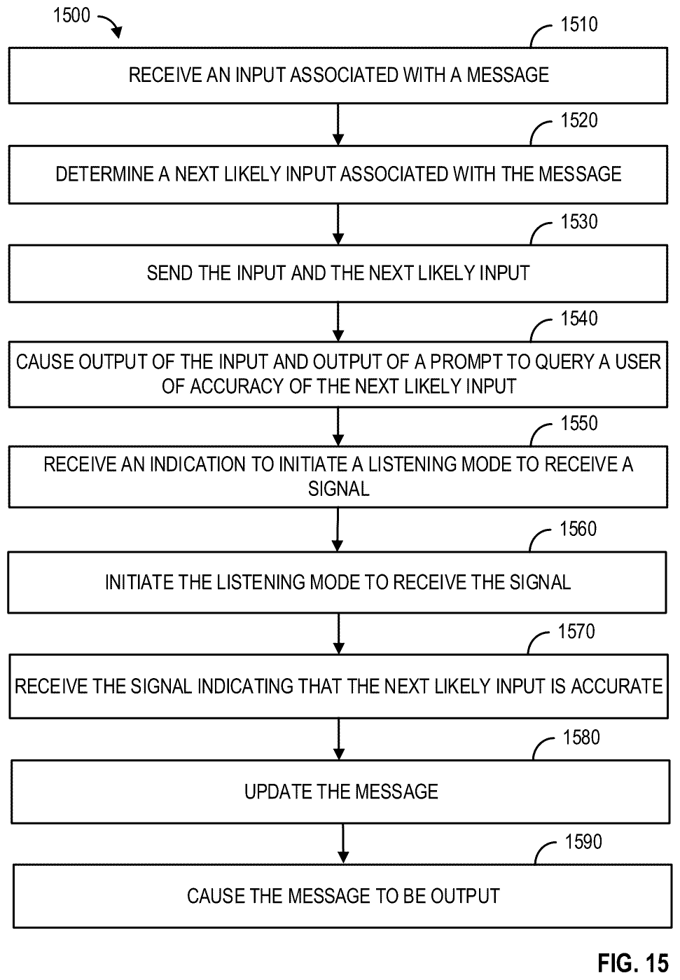

FIG. 15 shows an example method 1500 for enhancing user interaction with assistive technology. The method 1500 may be performed by any device, such as the computing device 102, the mobile device 103 (or a user device of a third party assistant), or the server 104. At 1510, an input associated with a message may be received. For example, the computing device 102 may receive the input associated with the message from an assistive communication device 101. The input received from the assistive communication device 101 may comprise one or more of a letter (or a character), a word, or a phrase. In an example, the computing device 102 may receive a signal indicative of the input from the assistive communication device 101. The signal may comprise one or more of a binary selection, a muscle twitch, an eye movement, a body movement, a gesture, a voice, or neural signals. The computing device 102 may translate the signal received from the assistive communication device 101 into the input comprising one or more of a letter, a word, or a phrase. In another example, the assistive communication device 101 may receive the signal from a user with a disability and translate the signal into the input comprising one or more of a letter, a word, or a phrase. The assistive communication device 101 may send the input to the computing device 102.

The computing device 102 may include a communication interface such as a Bluetooth module, a cellular module, a Wi-Fi module, a Zigbee module, an NFC module, or any other short/long range communication module to communicate with external devices such as the assistive communication device 101, the mobile device 103, a user device, the server 104, and/or the network 105. The computing device 102 may be configured to display a machine-readable symbol, such as a QR code, bar code, another 2-dimensional code, a URL, or other type of symbol that can be scanned or accessed by the mobile device 103 or the user device.

The assistive communication device 101 may serve as the primary input mechanism to receive a signal indicative of the input from the user with a disability, which may operate in several modes to accommodate different types of disabilities and user preferences. Examples of the assistive communication device 101 may include, but are not limited to, a brain-computer interface, a muscle movement sensor, an eye-direction detector, a sip-and-puff system, a switch-based device, a voice-activated system, a specialized joystick, an adaptive keyboard, and a foot pedal. The signal, input, or message may comprise one or more of a word, a partial word, a letter, or a sentence that the user desired to spell.

At 1520, a next likely input associated with the message may be determined. The next likely input may comprise one or more of a letter, a word, punctuation, or a phrase. For example, the computing device 102 or the server 104 may determine the next likely input associated with the message based on one or more of an alphabetical grid, a Bayesian mode, a large language model, or a machine-learning model. For example, the computing device 102 may determine the next likely input based on the alphabetical grid using the grid-scanning mode as described in FIGS. 6A-B. In another example, the computing device 102 may determine the next likely input based on the Bayesian mode as described in FIGS. 8A-B. In another example, the computing device 102 may determine the next likely input based on one or more language models such as the N-gram model and the large language model (LLM) as described above. In another example, the computing device 102 may determine the next likely input based on one or more machine learning models as described in FIGS. 11-12.

At 1530, the input associated with the message and the next likely input associated with the message may be sent. For example, the computing device 102 may send the input associated with the message and the next likely input associated with the message to the mobile device 103 or the user device via a secure communication session. The secure communication session may be established by causing, at the computing device 102, a display of a symbol, receiving an indication that the mobile device 103 or the user device has detected the symbol, and initiating, based on the indication, the secure communication session with the mobile device 103 or the user device. In an example, the secure communication session may be one of a direct communication session between the computing device 102 and the user device (or the mobile device 103) or via the server 104.

At 1540, the output of the input associated with the message and the output of a prompt to query the user of the assistive communication device 101 of the accuracy of the next likely input associated with the message may be caused. For example, the computing device 102 may cause, via the secure communication session, the output of the input associated with the message and the output of a prompt to query a user of the assistive communication device 101 of the accuracy of the next likely input associated with the message. For example, the computing device 102 may cause the output of the input associated with the message and the output of the prompt to query a user of the assistive communication device 101 of the accuracy of the next likely input associated with the message at the mobile device 103 or the user device. For example, the mobile device 103 or the user device that established the secure compunction session with the computing device 102 may display the output of the input associated with the message and the output of a prompt to query the user of the assistive communication device 101 about the accuracy of the next likely input. For example, the prompt to query a user of the assistive communication device 101 of the accuracy of the next likely input associated with the message may comprises the determined next likely input associated with the message. For example, the input associated with the message may be displayed on the first portion 201 of the user interface 200 in FIG. 2. The prompt may comprise one or more of a “yes” indicator or a “no” indicator, as shown in FIG. 2. For example, the “yes” indicator and the “no” indicator may be used/displayed in the manual mode described above. The prompt may comprise a “go” indicator as shown in FIG. 5. The “go” indicator may be used/displayed in the automatic mode described above. Once the “go” indicator is depressed or enabled, the mobile device 103 or the user device may send the indication to initiate a listening mode to the computing device 102.

At 1560, an indication to initiate a listening mode may be received. For example, the computing device 102 may receive the indication to initiate the listening mode via the secured communication session. For example, when the automatic mode is initiated by enabling the “go” indicator, the computing device 102 may receive, from the mobile device 103 or the user device, the indication to initiate the listening mode to receive a signal from the assistive communication device 101 (e.g., BCI). At 1570, the listening mode to receive the signal from the assistive communication device 101 may be received. For example, once the listening mode is initiated in the computing device 102, the computing device 102 may monitor the signal from the assistive communication device 101.

At 1570, the signal indicating that the next likely input associated with the message is accurate may be received. For example, the computing device 102 may receive the signal indicating that the next likely input associated with the message is accurate from the assistive communication device 101. For example, the signal may comprise one or more of a binary selection, a muscle twitch, an eye movement, a body movement, a gesture, a voice, or neural signals. The computing device 102 may interpret the signal to determine whether the next likely input associated with the message is accurate. For example, the computing device 102 may translate the signal received from the assistive communication device 101 into a “yes” indication or a “no” indication. If the signal received from the assistive communication device 101 corresponds to the “yes” indication, the computing device 102 may determine that the next likely input associated with the message is accurate.

Additionally or alternatively, the computing device 102 may receive the signal indicating that the next likely input associated with the message is not accurate from the assistive communication device 101. For example, the signal may comprise one or more of a binary selection, a muscle twitch, an eye movement, a body movement, a gesture, a voice, or neural signals. The computing device 102 may interpret the signal to determine whether the next likely input associated with the message is accurate. For example, the computing device 102 may translate the signal received from the assistive communication device 101 into a “yes” indication or a “no” indication. If the signal received from the assistive communication device 101 corresponds to the “no” indication, the computing device 102 may determine another next likely input associated with the message based on one or more of an alphabetical grid, a Bayesian mode, a large language model, or a machine-learning model as described above.

At 1580, the message may be updated. For example, the computing device 102 may update the message based on the next likely input associated with the message. For example, the computing device 102 may update the message based on the signal indicating that the next likely input associated with the message is accurate. For example, the computing device 102 may determine another indication of the next likely input based on the signal indicating that the next likely input associated with the message is accurate. Another indication of the next likely input may comprise a plurality of letters. A portion of the plurality of letters may be determined as a next letter to be added to the message. For example, the computing device 102 may determine, based on another indication, the portion of the plurality of letters as the next letter to be added to the message. The output of the portion of the plurality of letters may be caused or displayed, via the secure communication session, on the user interface (e.g., user interface 200) of the mobile device 103 or the user device. An indication that the portion of the plurality of letters comprises the next letter to be added to the message may be received via the secure communication session. For example, the computing device 102 may receive the indication that the portion of the plurality of letters comprises the next letter from the mobile device 103, the user device, and/or the assistive communication device 101. The message may be updated by adding the next letter to the message.

At 1590, the message may be caused to be output. For example, the computing device 102 may cause the mobile device 103 or the user device to output the message. For example, the message may be output or displayed via the user interface (e.g., user interface 200) of the mobile device 103 or the user device.

An example method for enhancing user interaction with assistive technology is described herein. For example, an assistive input method configured to communicate with software running on the computing device 102 may be provided. The assistive input method may include at least one of an eye-tracking system, a head-tracking system, or a brain-computer interface (BCI). The software running on the computing device 102 may be configured to receive input from the assistive input method and to display the input as letters and/or words on a display screen. The software running on the computing device 102 may be configured to adapt the predictive questions based on historical input patterns of the user with a disability. The software running on the computing device 102 may be configured to provide auditory feedback corresponding to the text being spelled out by the user with a disability.

The software running on the computing device 102 may be configured to display a machine-readable symbol, such as a QR code, a bar code, or another 2-dimensional code. For example, when scanned by the mobile device 103, the software running on the computing device 102 may permit the mobile device 103 to establish communication with the software on the computing device. Upon establishing communication, the mobile device 103 may be configured to operate as a secure terminal to enable a third party to assist a user with a disability in continuing or initiating the composition of a message through an interface generated on the mobile device 103. A first portion displaying text that the user with a disability is spelling out using the assistive input method may be generated on the interface (e.g., user interface 200) of the mobile device 103. A second portion displaying a predictive question related to the text being spelled out by the user with a disability may be generated on the interface (e.g., user interface 200) of the mobile device 103. The predictive question may be intended to assist the user in completing the text more quickly by predicting the intended input. A response from the user with a disability to the predictive question may be received through a user response method, such as blinking or nodding. The user response method may further include at least one of a gesture recognition system, a touch-sensitive surface, or a voice command detection system.

A third portion enabling the third party to interact with the interface to indicate an affirmative or negative response to the predictive question may be generated on the interface (e.g., user interface 200) of the mobile device 103. In an example, the third portion of the interface may include a virtual keyboard for the third party to assist in composing the message. The efficient and effective communication by the user with a disability may be facilitated through the interaction of the third party with the third portion of the interface. The software running on the computing device 102 may be configured to store the composed message in a memory of the computing device 102 for future retrieval and editing by the user with a disability.

An example method for facilitating communication in an automatic mode for a user with a disability using assistive technology is described herein. A brain-computer interface (BCI) may be provided as an assistive input method configured to communicate with software running on the computing device 102. The software running on the computing device 102 may be configured to receive input from the brain-computer interface and to display the input as letters and/or words on a display screen. The software on the computing device 102 may be configured to display a machine-readable symbol, such as a QR code, that, when scanned by the mobile device 103, permits the mobile device 103 to establish communication with the software on the computing device 102. The machine-readable symbol may be dynamically generated to include encryption for securing the communication between the mobile device 103 and the computing device 102. Upon establishing communication, the mobile device 103 may be configured to operate as a secure terminal to enable a third party to assist the user with a disability in continuing or initiating the composition of a message through an interface generated on the mobile device 103.

A first portion displaying text that the user with a disability is spelling out using the brain-computer interface may be generated on the interface (e.g., user interface 200) of the mobile device 103. A second portion displaying a predictive question related to the text being spelled out by the user with a disability may be generated on the interface of the mobile device. The predictive question may be intended to assist the user in completing the text more quickly by predicting the intended input. The third party may be enabled to judge when the user with a disability is ready to respond to the predictive question and to activate a “go” button in a third portion of the interface. An automatic response from the user with a disability to the predictive question may be received through the brain-computer interface. The response may comprise a “yes” or “no” signal sent to the mobile device 103 to indicate whether the predicted text is correct. The efficient and effective communication by the user with a disability may be facilitated through the interaction of the third party with the third portion of the interface and the automatic response from the user with a disability.

In an example, the software running on the computing device 102 may be configured to allow the user with a disability to select from multiple assistive input methods based on their current physical condition or preferences. In another example, the software running on the computing device 102 may be configured to translate the composed message into one or more different languages to facilitate communication with a third party who speaks a different language. In another example, the software running on the computing device 102 may be configured to analyze the context of the conversation and provide contextually relevant predictive questions to the user with a disability. In another example, the software running on the computing device 102 may be configured to learn from the selections and responses of the user to improve the accuracy of the predictive questions over time. In another example, the software running on the computing device 102 may be configured to provide visual feedback, such as highlighting or animating text, to assist the user with a disability in tracking the text being spelled out.

An example method for facilitating communication using a grid-scanning mode for a user with a disability is described herein. For example, an assistive input method configured to communicate with software running on a computing device may be provided. The software running on the computing device 102 may be configured to receive input from the assistive input method and to display the input as letters and/or words on a display screen. The software on the computing device 102 may be configured to display a machine-readable symbol, such as a QR code, that, when scanned by the mobile device 103, permits the mobile device 103 to establish communication with the software on the computing device 102. Upon establishing communication, the mobile device 103 may be configured to operate as a secure terminal to enable a third party to assist the user with a disability in continuing or initiating the composition of a message through an interface generated on the mobile device 103.

A first portion displaying text that the user with a disability is spelling out using the assistive input method within a predefined alphabetical grid that divides the alphabet into rows may be generated on the interface (e.g., user interface 200) of the mobile device 103. A second portion displaying a question related to the text being spelled out by the user with a disability may be generated on the interface (e.g., user interface 200) of the mobile device 103. The question may be intended to assist the user in completing the text more quickly by inquiring which row and then which letter within the row the user intends to select. A response from the user with a disability to the question through a user response method, such as blinking or nodding may be received. A third portion enabling the third party to interact with the interface to indicate an affirmative or negative response to the question may be generated on the interface of the mobile device 103. The efficient and effective communication by the user with a disability may be facilitated through the interaction of the third party with the third portion of the interface.

In an example, the software running on the computing device 102 may be configured to customize the layout of the interface on the mobile device 103 based on the preferences or requirements of the third party assisting the user with a disability. In another example, the software running on the computing device 102 may be configured to enable the user with a disability to initiate a request for assistance from the third party through the assistive input method. In another example, the software running on the computing device 102 may be configured to provide haptic feedback on the mobile device 103 in response to the input of the user with a disability or the interactions of the third party with the interface. In another example, the software running on the computing device 102 may be configured to display visual cues on the mobile device interface to guide the third party in assisting the user with a disability more effectively. In another example, the software running on the computing device 102 may be configured to enable the third party to send pre-composed messages to the user with a disability for selection and confirmation through the assistive input method. In another example, the software running on the computing device 102 may be configured to allow the user with a disability to review and edit the message composed with the assistance of the third party before it is finalized.

An example method for facilitating communication using a Bayesian mode for a user with a disability is described herein. For example, an assistive input method configured to communicate with software running on a computing device 102 may be provided. The assistive input method may include at least one of an eye-tracking system, a head-tracking system, or a brain-computer interface. The software running on the computing device 102 may be configured to receive input from the assistive input method and to display the input as letters and/or words on a display screen. The software on the computing device 102 may be configured to display a machine-readable symbol, such as a QR code, that, when scanned by the mobile device 103, permits the mobile device 103 to establish communication with the software on the computing device 102. The machine-readable symbol may be dynamically generated to include encryption for securing the communication between the mobile device and the computing device. Upon establishing communication, the mobile device 103 may be configured to operate as a secure terminal to enable a third party to assist the user with a disability in continuing or initiating the composition of a message through an interface generated on the mobile device 103.

A first portion displaying text that the user with a disability is spelling out using the assistive input method may be generated on the interface of the mobile device 103. A second portion displaying a predictive question related to the text being spelled out by the user with a disability may be generated on the interface of the mobile device 103. The predictive question may be generated using Bayesian predictive techniques to predict letters and/or words that are more likely to be used next based on previous input. A response from the user with a disability to the predictive question through a user response method, such as blinking or nodding may be received. The user response method may further include at least one of a gesture recognition system, a touch-sensitive surface, or a voice command detection system. A third portion enabling the third party to interact with the interface to indicate an affirmative or negative response to the predictive question may be generated on the interface of the mobile device 103. The third portion of the interface may include a virtual keyboard for the third party to assist in composing the message. The efficient and effective communication by the user with a disability may be facilitated through the interaction of the third party with the third portion of the interface.

In an example, the software running on the computing device 102 may be configured to automatically adjust the sensitivity of the assistive input method based on real-time (or near-real-time) analysis of the interaction patterns of the user to enhance the accuracy of input recognition. In another example, the software running on the computing device 102 may be configured to enable the user with a disability to customize the appearance of the text, such as font size and color, on the display screen to accommodate their visual preferences. In another example, the software running on the computing device 102 may be configured to integrate with social media platforms, thereby allowing the user with a disability to communicate directly through the interface on the mobile device with their social media accounts. In another example, the software running on the computing device 102 may be configured to provide the third party with suggestions for facilitating communication based on the disability type of the user and the context of the conversation.

In another example, the software running on the computing device 102 may be configured to enable the user with a disability to control environmental devices, such as lights or televisions, through the assistive input method as part of the communication process. In another example, the software running on the computing device 102 may be configured to allow the third party to access a history of the composed messages of the user to better understand the communication style and preferences of the user. In another example, the software running on the computing device 102 may be configured to adapt the predictive questions based on historical input patterns of the user with a disability. In another example, the software running on the computing device 102 may be configured to provide auditory feedback corresponding to the text being spelled out by the user with a disability.

In another example, the software running on the computing device 102 may be configured to store the composed message in a memory of the computing device for future retrieval and editing by the user with a disability. In another example, the software running on the computing device 102 may be configured to allow the user with a disability to select from multiple assistive input methods based on their current physical condition or preferences. In another example, the software running on the computing device 102 may be configured to translate the composed message into one or more different languages to facilitate communication with a third party who speaks a different language. In another example, the software running on the computing device 102 may be configured to analyze the context of the conversation and provide contextually relevant predictive questions to the user with a disability.

In another example, the software running on the computing device 102 may be configured to learn from the selections and responses of the user to improve the accuracy of the predictive questions over time. In another example, the software running on the computing device 102 may be configured to provide visual feedback, such as highlighting or animating text, to assist the user with a disability in tracking the text being spelled out. In another example, the software running on the computing device 102 may be configured to customize the layout of the interface on the mobile device based on the preferences or requirements of the third party assisting the user with a disability. In another example, the software running on the computing device 102 may be configured to enable the user with a disability to initiate a request for assistance from the third party through the assistive input method.

In another example, the software running on the computing device 102 may be configured to provide haptic feedback on the mobile device in response to the input of the user with a disability or the interactions of the third party with the interface. In another example, the software running on the computing device 102 may be configured to display visual cues on the mobile device interface to guide the third party in assisting the user with a disability more effectively. In another example, the software running on the computing device 102 may be configured to enable the third party to send pre-composed messages to the user with a disability for selection and confirmation through the assistive input method. In another example, the software running on the computing device 102 may be configured to allow the user with a disability to review and edit the message composed with the assistance of the third party before it is finalized.

In another example, the software running on the computing device 102 may be configured to automatically adjust the sensitivity of the assistive input method based on real-time (or near-real-time) analysis of the interaction patterns of the user to enhance the accuracy of input recognition. In another example, the software running on the computing device 102 may be configured to enable the user with a disability to customize the appearance of the text, such as font size and color, on the display screen to accommodate their visual preferences. In another example, the software running on the computing device 102 may be configured to integrate with social media platforms, thereby allowing the user with a disability to communicate directly through the interface on the mobile device with their social media accounts. In another example, the software running on the computing device 102 may be configured to provide the third party with suggestions for facilitating communication based on the disability type of the user and the context of the conversation. In another example, the software running on the computing device 102 may be configured to enable the user with a disability to control environmental devices, such as lights or televisions, through the assistive input method as part of the communication process. In another example, the software running on the computing device 102 may be configured to allow the third party to access a history of the composed messages of the user to better understand the communication style and preferences of the user.

An example system for enhancing user interaction with assistive technology is described herein. For example, the system may comprise an assistive communication device, a computing device, and a mobile device. The assistive communication device (e.g., the assistive communication device 101) may be configured to be operable by a user with a disability to select letters and spell out words. The assistive communication device may include a thumb switch, facial muscle twitch sensor, blink sensor, eye movement tracker, or a brain-computer interface. The assistive communication device may be further configured to recognize binary inputs such as eye blinks and muscle twitches, or to operate in a grid-scanning mode or a Bayesian mode for predicting subsequent letters or words based on previous input. The computing device (e.g., the computing device 102) may be in communication with the assistive communication device. The computing device may comprise software configured to receive input from the assistive communication device and to display the composed letters and/or words on a display screen. The software may be further configured to generate a machine-readable symbol, such as a QR code, for establishing communication with a mobile device.

The mobile device (e.g., the mobile device 103) may be configured to scan the machine-readable symbol displayed by the computing device and to establish a secure communication channel with the computing device. Upon establishing communication, the mobile device may operate as a secure terminal through which a third party can assist the user with a disability in continuing or initiating the composition of a message via an interface generated on the mobile device. The interface (e.g., user interface 200) may include portions for displaying text being spelled out by the user, presenting predictive questions to assist in message composition, and enabling the third party to interact with the system to facilitate efficient and effective communication by the user with a disability.

In an example, the software running on the computing device may be configured to adjust the complexity of the Bayesian predictive questions based on the proficiency of the user with the assistive input method. In another example, the software running on the computing device may be configured to provide auditory cues corresponding to the predictive questions to facilitate understanding by the user with a disability. In another example, the software running on the computing device may be configured to allow the user with a disability to customize the timing for when predictive questions are presented, based on their individual response speed. In another example, the software running on the computing device may be configured to utilize a machine learning algorithm to refine the Bayesian predictive model based on the interaction history of the user. In another example, the software running on the computing device may be configured to enable the third party to manually adjust the Bayesian predictive model in real-time or near-real-time to better align with the intended communication of the user. In another example, the software running on the computing device may be configured to provide a feedback mechanism for the user with a disability to indicate the relevance of the predictive questions, thereby allowing for continuous improvement of the Bayesian predictive model.

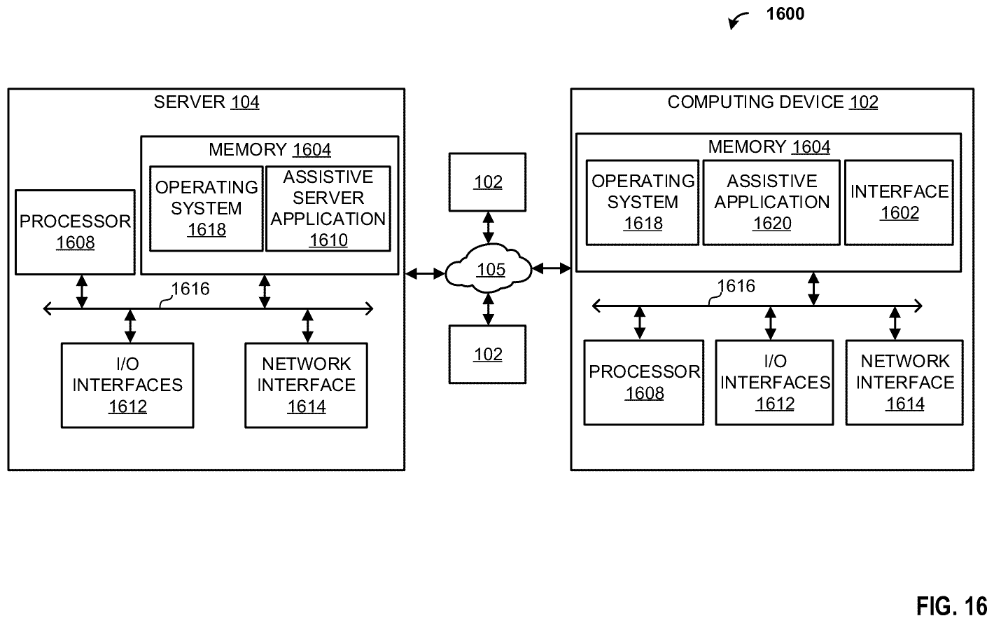

FIG. 16 is a block diagram depicting a communication system 1600 comprising non-limiting examples of the computing device 102 and the server 104 connected through the network 105. In an aspect, some or all steps of any described method may be performed on a computing device as described herein. The computing device 102 can comprise one or multiple computers configured to store one or more of the assistive application 1620, user data, user profile and/or text data. The assistive application 1620 may perform the grid-scanning and Bayesian modes described in FIGS. 6, 8, the methods described in FIGS. 12-15, and/or other methods described above. The server 104 can comprise one or multiple computers configured to store one or more of the assistive server application 1610, user data, user profile, data for prediction models and the like. The assistive server application 1610 may alternatively perform some or all functionalities of the assistive application 1620 by performing the grid-scanning and Bayesian modes described in FIGS. 6, 8, the methods described in FIGS. 12-15, and/or other methods described above. Multiple computing devices 102 can connect to the server 104 through the network 105 such as, for example, the Internet. A user with a disability on the computing device 102 may connect to the assistive server application 1610 with the user interface associated with the computing device 102.

The server 104 and the computing device 102 can be a digital computer that, in terms of hardware architecture, generally includes a processor 1608, memory system 1604, input/output (I/O) interfaces 1612, and network interfaces 1614. These components (1604, 1608, 1612, and 1614) are communicatively coupled via a local interface 1616. The local interface 1616 can be, for example but not limited to, one or more buses or other wired or wireless connections, as is known in the art. The local interface 1616 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1608 can be a hardware device for executing software, particularly that stored in memory system 1604. The processor 1608 can be any custom made or commercially available processor, a central processing unit (CPU), an auxiliary processor among several processors associated with the server 104 and the computing device 102, a semiconductor-based microprocessor (in the form of a microchip or chip set), or generally any device for executing software instructions. When the server 104 and the computing device 102 are in operation, the processor 1608 can be configured to execute software stored within the memory system 1604, to communicate data to and from the memory system 1604, and to generally control operations of the server 104 and the computing device 102 pursuant to the software.

The I/O interfaces 1612 can be used to receive user input from and/or for providing system output to one or more devices or components. User input can be provided via, for example, a keyboard and/or a mouse. System output can be provided via a display device and a printer (not shown). I/O interfaces 1612 can include, for example, a serial port, a parallel port, a Small Computer System Interface (SCSI), an IR interface, an RF interface, and/or a universal serial bus (USB) interface.

The network interface 1614 can be used to transmit and receive from the server 104 or the computing device 102 on the network 105. The network interface 1614 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi), or any other suitable network interface device. The network interface 1614 may include address, control, and/or data connections to enable appropriate communications on the network 105.

The memory system 1604 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 1604 may incorporate electronic, magnetic, optical, and/or other types of storage media. Note that the memory system 1604 can have a distributed architecture, where various components are situated remote from one another, but can be accessed by the processor 1608.

The software in memory system 1604 may include one or more software programs, each of which comprises an ordered listing of executable instructions for implementing logical functions. In the example of FIG. 16, the software in the memory system 1604 of the server 104 can comprise the assistive server application 1610 (or subcomponents thereof) and a suitable operating system (O/S) 1618. In the example of FIG. 16, the software in the memory system 1604 of the computing device 102 can comprise the assistive application 1620, and a suitable operating system (O/S) 1618. The operating system 1618 essentially controls the execution of other computer programs, such as the operating system 1618, the assistive server application 1610, and/or the assistive application 1620, and provides scheduling, input-output control, file and data management, memory management, and communication control and related services.

For purposes of illustration, application programs and other executable program components such as the operating system 1618 are illustrated herein as discrete blocks, although it is recognized that such programs and components can reside at various times in different storage components of the sever 104 and/or the computing device 102. An implementation of the assistive server application 1610, and/or the assistive application 1620 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving, by a computing device, from an assistive communication device, an input associated with a message;
determining a next likely input associated with the message;
sending, via a secure communication session, to a user device, the input associated with the message and the next likely input associated with the message;
causing, via the secure communication session, via an interface of the user device, output of the input associated with the message and output of a prompt to query a user of the assistive communication device of accuracy of the next likely input associated with the message;
receiving, via the secure communication session, an indication that the next likely input associated with the message is accurate;
updating, based on the next likely input associated with the message, the message; and
causing the message to be output.

2. The method of claim 1, wherein the next likely input comprises one or more of a letter, a word, or a phrase.

3. The method of claim 1, wherein the message comprises one or more of a word, a partial word, a letter, or a sentence.

4. The method of claim 1, wherein the indication of the next likely input comprises a plurality of letters, the method further comprising:
determining a portion of the plurality of letters as a next letter to be added to the message;
causing, via the secure communication session, via the interface of the user device, output of the portion of the plurality of letters; and
receiving, via the secure communication session, an indication that the portion of the plurality of letters comprises the next letter to be added to the message,
wherein updating the message comprises adding the next letter to be added to the message.

5. The method of claim 1, further comprising:
causing, at the computing device, a display of a symbol;
receiving an indication that the user device has detected the symbol; and
initiating, based on the indication, the secure communication session with the user device.

6. The method of claim 1, wherein the prompt comprises one or more of a yes indicator or a no indicator.

7. The method of claim 1, wherein the prompt comprise a go indicator, wherein the assistive communication device comprises a brain-computer interface (BCI), and wherein the indication that the next likely input associated with the message is accurate is received via the BCI.

8. The method of claim 1, wherein the assistive communication device is one or more of a brain-computer interface, a muscle movement sensor, or an eye-direction detector.

9. A method comprising:
receiving, by a computing device, from an assistive communication device, an input associated with a message;
determining a next likely input associated with the message;
sending, via a secure communication session, to a user device, the input associated with the message and the next likely input associated with the message;
causing, via the secure communication session, via an interface of the user device, output of the input associated with the message and output of a prompt to query a user of the assistive communication device of accuracy of the next likely input associated with the message;
receiving, via the secure communication session, an indication that the next likely input associated with the message is wrong; and
determining another next likely input associated with the message.

10. The method of claim 9, further comprising:
sending, via the secure communication session, to the user device, the another next likely input associated with the message;
causing, via the secure communication session, via the interface of the user device, output of a second prompt to query the user of the assistive communication device of an accuracy of the another next likely input associated with the message;
receiving, via the secure communication session, an indication that the another next likely input associated with the message is accurate;
updating, based on the another next likely input associated with the message, the message; and
causing the message to be output.

11. The method of claim 9, wherein each of the next likely input and the another next likely input comprises one or more of a letter, a word, or a phrase and wherein the message comprises one or more of a word, a partial word, a letter, or a sentence.

12. The method of claim 9, wherein the indication of the next likely input comprises a plurality of letters, the method further comprising:
determining a portion of the plurality of letters as a next letter to be added to the message;
causing, via the secure communication session, via the interface of the user device, output of the portion of the plurality of letters; and
receiving, via the secure communication session, an indication that the portion of the plurality of letters comprises the next letter to be added to the message,
wherein updating the message comprises adding the next letter to be added to the message.

13. The method of claim 9, wherein one or more of the next likely input or the another next likely input is determined based on one or more of an alphabetical grid, a Bayesian mode, or a large language model.

14. The method of claim 9, wherein the prompt comprises one or more of a yes indicator or a no indicator.

15. The method of claim 9, wherein the prompt comprises a go indicator, wherein the assistive communication device comprises a brain-computer interface (BCI), and wherein the indication that the next likely input associated with the message is wrong is received via the BCI.

16. A method comprising:
receiving, by a computing device, an input associated with a message;
determining a next likely input associated with the message;
sending, via a secure communication session, to a user device, the input associated with the message and the next likely input associated with the message;
causing, via the secure communication session, via an interface of the user device, output of the input associated with the message and output of a prompt to query a user of an assistive communication device of accuracy of the next likely input associated with the message;
receiving, via the secure communication session, an indication to initiate a listening mode to receive a signal from an assistive communication device;
initiating the listening mode to receive the signal from the assistive communication device;
receiving, from the assistive communication device, the signal indicating that the next likely input associated with the message is accurate;
updating, based on the next likely input associated with the message, the message; and
causing the message to be output.

17. The method of claim 16, wherein the next likely input comprises one or more of a letter, a word, or a phrase and wherein the message comprises one or more of a word, a partial word, a letter, or a sentence.

18. The method of claim 16, further comprising:
determining, based on the signal indicating that the next likely input associated with the message is accurate, another indication of the next likely input comprising a plurality of letters;
determining a portion of the plurality of letters as a next letter to be added to the message;
causing, via the secure communication session, via the interface of the user device, output of the portion of the plurality of letters; and
receiving, from the assistive communication device, an indication that the portion of the plurality of letters comprises the next letter to be added to the message;
wherein updating the message comprises adding the next letter to be added to the message.

19. The method of claim 16, wherein the next likely input is determined based on one or more of an alphabetical grid, a Bayesian mode, or a large language model.

20. The method of claim 16, wherein the prompt comprises a go indicator, a user input at the go indicator causes the indication to initiate the listening mode.
